(19) United States
(12) Patent Application Publication
(10) Pub. No.: US 2019/0043506 A1
(43) Pub. Date: Feb. 7, 2019

(54) METHODS AND SYSTEMS FOR TRANSCRIPTION

(71) Applicant: Veritone, Inc., Costa Mesa, CA (US)

(72) Inventors: Steven N. Rivkin, Laguna Niguel, CA (US); Peter Nguyen, Costa Mesa, CA (US); Cornelius Raths, Costa Mesa, CA (US); Chad Steelberg, Irvine, CA (US)

(21) Appl. No.: 16/052,459

(22) Filed: Aug. 1, 2018

Related U.S. Application Data
(60) Provisional application No. 62/638,745, filed on Mar. 5, 2018.
(60) Provisional application No. 62/633,023, filed on Feb. 20, 2018.
(60) Provisional application No. 62/540,508, filed on Aug. 2, 2017.

(51) Int. Cl. G10L 15/32; G10L 15/18; G06F 17/27; G10L 15/02

(52) U.S. Cl. CPC G10L 15/32; G10L 15/1815; G10L 15/02; G06F 17/274; G06F 17/2785; G06F 17/277

(57) ABSTRACT

A method of transcription a media file is provided. The method includes: receiving, from a first transcription engine, one or more transcribed portions of a media file; identifying a first transcribed portion from the one or more transcribed portions that needs to be reexamined based at least on metadata of the media file; selecting a second transcription engine to transcribe a first segment of the media file corresponding to the first transcribed portion; receiving, from the second transcription engine, a second transcribed portion of the first segment; determining confidences of accuracy of the first and second transcribed portions of the first segment based at least on metadata of the first and second transcribed portions, respectively; and selecting the first or second transcribed portion as transcript for the first segment of the media file based at least on confidences of accuracy of the first and second transcribed portions.

### CROSS-REFERENCE TO RELATED APPLICATIONS

This application claims priority to and benefit of U.S. Provisional Application No. 62/540,508, filed Aug. 2, 2017, and to U.S. Provisional Application No. 62/633,023, filed on Feb. 20, 2018, and to U.S. Provisional Application No. 62/638,745, filed Mar. 5, 2018, the disclosures of all of which are incorporated herein by reference in their entireties for all purposes.

This application is related to the subject matter disclosed in U.S. Non-Provisional application Ser. No. 15/922,802, filed on Mar. 15, 2018, and to U.S. Non-Provisional application Ser. No. 15/950,102, filed on Apr. 10, 2018, the disclosures of both of which are incorporated herein by reference in their entireties for all purposes.

### BACKGROUND

Based on one estimate, 90% of all data in the world today are generated during the last two years. Quantitively, that is more than 2.5 quintillion bytes of data are being generated every day; and this rate is accelerating. This estimate does not include ephemeral media such as live radio and video broadcasts, most of which are not stored.

To be competitive in the current business climate, businesses should process and analyze big data to discover market trends, customer behaviors, and other useful indicators relating to their markets, product, and/or services. Conventional business intelligence methods traditionally rely on data collected by data warehouses, which is mainly structured data of limited scope (e.g., data collected from surveys and at point of sales). As such, businesses must explore big data (e.g., structured, unstructured, and semi-structured data) to gain a better understanding of their markets and customers. However, gathering, processing, and analyzing big data is a tremendous task to take on for any corporation.

Additionally, it is estimated that about 80% of the world data is unreadable by machines. Ignoring this large portion of unreadable data could potentially mean ignoring 80% of the additional data points. Accordingly, to conduct proper business intelligence studies, businesses need a way to collect, process, and analyze big data, including machine unreadable data.

### SUMMARY

Various approaches are described herein for, among other things, optimizing the selection of one or more transcription engines to transcribe a media file. In a first example method for transcribing a media file using one or more processors, a list of transcription engines is generated using a trained machine learning model based at least on the media file. A first transcription engine, from the list of transcription engines, is requested to transcribe the media file. In response to requesting the first transcription engine to transcribe the media file, one or more transcribed portions of the media file are received. In the example method, a first transcribed portion from the one or more transcribed portions that needs to be reexamined is identified. A second transcription engine, from the list of transcription engines, is requested to transcribe a first segment of the media file corresponding to the first transcribed portion that needs to be reexamined. A second transcribed portion of the first segment is then received, from the second transcription engine, in response to requesting the second transcription engine to transcribe the first segment of the media file.

In a first example system for transcribing a media file, the system comprises a memory and one or more processors. The one or more processors are coupled to the memory, the one or more processors are configured to: generate, using a machine learning model, a list of transcription engines based on the media file; request a first transcription engine to transcribe the media file; receive, from the first transcription engine, a plurality of transcribed portions of the media file in response to requesting the first transcription engine to transcribe the media file; identify a first transcribed portion from the one or more transcribed portions that needs to be reexamined; request a second transcription engine to transcribe a first segment of the media file corresponding to the first transcribed portion that needs to be reexamined; and receive, from the second transcription engine, a second transcribed portion of the first segment in response to requesting the second transcription engine to transcribe the first segment of the media file.

In a second example method for transcription a media file using one or more processors, the method comprises: selecting, using a machine learning model, a first transcription engine to transcribe the media file; receiving, from the first transcription engine, one or more transcribed portions of the media file in response to selecting the first transcription engine; identifying a first transcribed portion from the one or more transcribed portions having a confidence of accuracy below a predetermined accuracy threshold; selecting, using the machine learning model, a second transcription engine to transcribe a first segment of the media file corresponding to the first transcribed portion, the first and second transcription engines are different; receiving, from the second transcription engine, a second transcribed portion of the first segment; and selecting the first or second transcribed portion as transcript of the first segment of the media file based at least on confidences of accuracy of the first and second transcribed portions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, like reference numerals designate corresponding parts throughout the different views.

FIG. 1 illustrates a high-level flow diagram depicting a process for optimizing the selection of transcription engines using a combination of selected preprocessors, according to some aspects of the disclosure.

FIG. 2A illustrates a high-level block diagram showing a training process and a production process, according to some aspects of the disclosure.

FIG. 2B illustrates an exemplary detailed process flow of a training process, according to some aspects of the disclosure.

FIG. 2C illustrates an exemplary flow diagram illustrating a first portion of a transcription engine selection optimization production process, according to some aspects of the disclosure.

FIG. 2D illustrates an exemplary flow diagram illustrating a second portion of a transcription engine selection optimization production process, according to some aspects of the disclosure.

FIGS. 3A and 3B illustrate transcription processes in accordance with some embodiments of the present disclosure.

FIG. 4 illustrates a transcription process in accordance with some embodiments of the present disclosure.

FIG. 5 illustrates a clustering process in accordance with some embodiments of the present disclosure.

FIGS. 6 and 7 illustrate transcription processes in accordance with some embodiments of the present disclosure.

FIG. 8 illustrates an exemplary table of candidate words and their confidence level in accordance with some embodiments of the present disclosure.

FIGS. 9 and 10 illustrate transcription processes in accordance with some embodiments of the present disclosure.

FIG. 11 illustrates a transcription confidence chart of an example transcribed portion in accordance with some embodiments of the present disclosure.

FIG. 12 illustrates a transcription confidence chart of transcribed portion after one or more re-transcription cycles in accordance with some embodiments of the present disclosure.

FIG. 13 is a chart illustrating the improvement of the transcription accuracy of the conductor as implement in accordance with some embodiments of the present disclosure.

FIG. 14 illustrates a block diagram of a transcription engine optimization and selection in accordance with some embodiments of the present disclosure.

FIG. 15 illustrates a block diagram of a transcription system in accordance with some embodiments of the present disclosure.

### DETAILED DESCRIPTION

The below described figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

### Overview

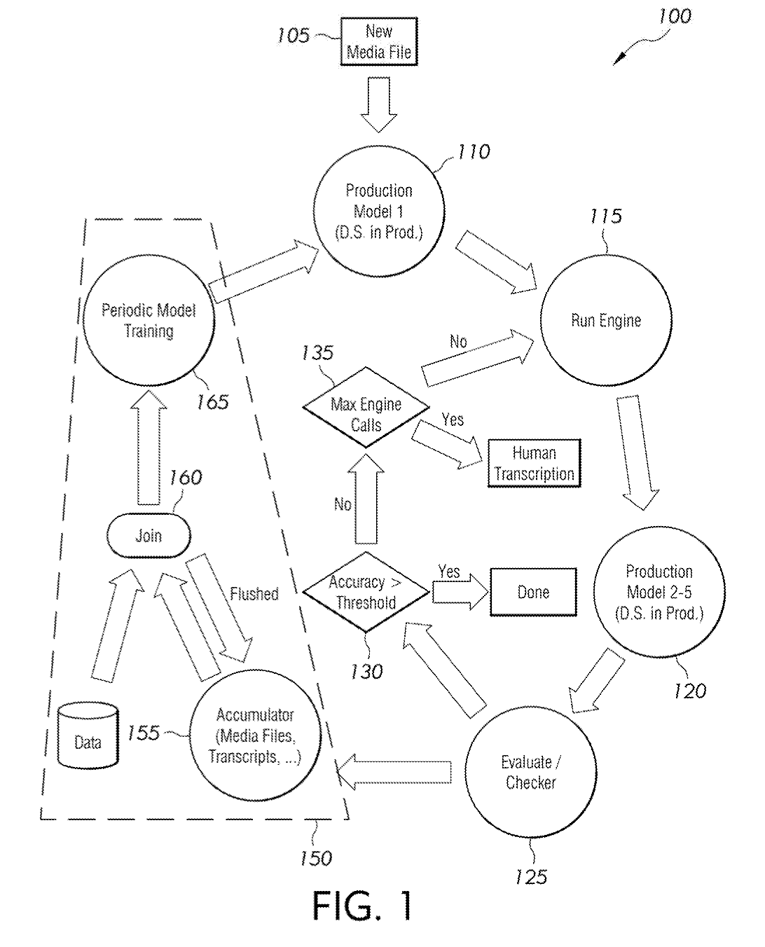

FIG. 1 is a high-level flow diagram depicting a process 100 for training transcription models, and for optimizing the selection of transcription engine(s) to transcribe media files in accordance with some embodiments of the disclosure. Process 100 can use a combination of preprocessors, machine learning models, transcription engines to generate one or more optimal transcripts. Media files as used herein may include audio data, image data, video data, or a combination thereof. Transcripts may generally include transcribed texts of the audio portion of the media files. Transcripts may be generated and stored in segments having start times, end times, duration, text specific metadata, etc. Process 100 may use one or more network-connected servers, each including one or more processors and non-transitory computer readable memory storing instructions that when executed cause the processors to: use multiple preprocessors (data processing modules) to process media files for features identification and extraction, and to create a feature profile for the media files; to create transcription models based on created feature profile; and to generate, with the use of one or more machine learning algorithms, a list of ranked transcription engines.

A machine learning algorithm is an algorithm that is able to learn from data. For example, a computer program is said to learn from experience ‘E’ with respect to some class of tasks ‘T’ and performance measure ‘P’, if its performance at tasks in ‘T’, as measured by ‘P’, improves with experience ‘E’. Examples of machine learning algorithm may include, but not limited to: a deep learning neural network; a feedforward neural network, a recurrent neural network, a support vector machine learning neural network, and a generative adversarial neural network.

Process 100 starts at 105 where a new media file to be transcribed is received. As described later at 150, each time a new media file is received for transcription, it may also be used for training existing transcription models in the system. The new media file (input file) may be a multimedia file containing audio data, image data, video data, external data such as keywords, along with metadata (e.g., knowledge from previous media files, previous transcripts, confidence indicator, etc.), or a combination thereof. Once the input file is received, it goes through several preprocessors to condition, normalize, and/or to extract features in the content (data) of the input file prior to being used as inputs of a transcription model. In some embodiments, features may be deleted, modified, and/or added to the feature profile of the media file. For example, brackets and other non-alphanumeric characters can be deleted. In another example, alphanumeric variables of one or more features (e.g., file type and encoding algorithm) can be converted into numeric variables for further processing (e.g., categorization and standardization). Features identification and ranking may be done using statistical tools such as a histogram. Audio features may include pitch (frequency), rhythm, noise ratios, length of sounds, intensity, relative power, silence, volume distribution, pitch contour, etc. Features may also include relationships between words, sentiment, recognized speech, accent, topics (e.g., sports, documentary, romance, sci-fi, politics, legal, etc.), and audio analysis variables such as mel-frequency cepstral coefficients (MFCC). Image features may include structures such as points, edges, shapes defined in terms of curves or boundaries between different image regions, or to properties of such a region, etc. Video features may include color (RGB pixel values), intensity, edge detection value, corner detection value, linear edge detection value, ridge detection value, valley detection value, etc.

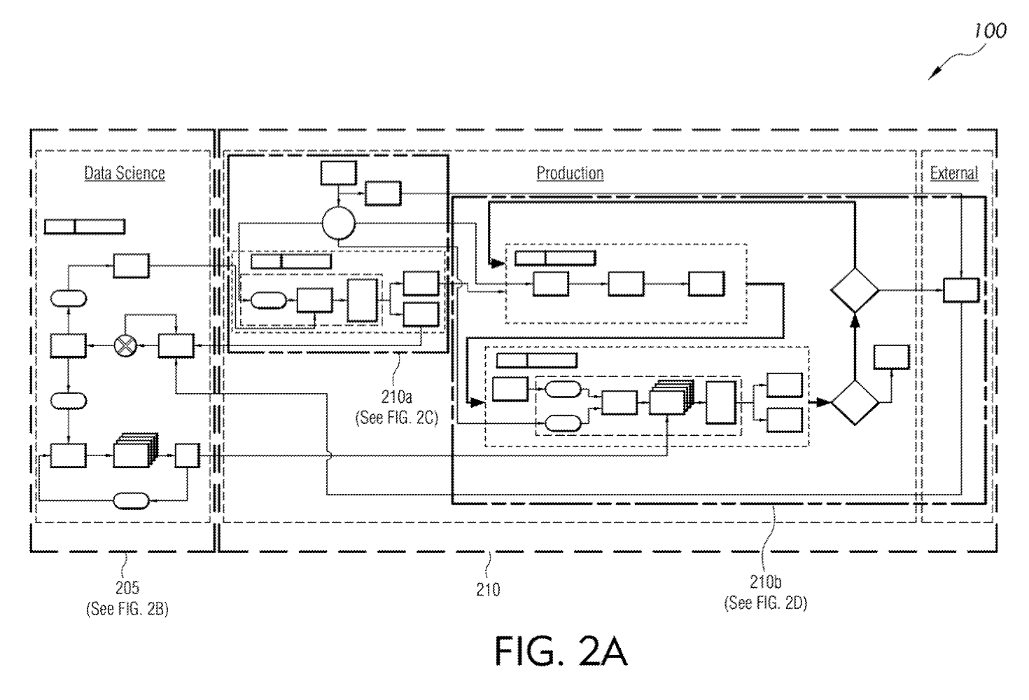

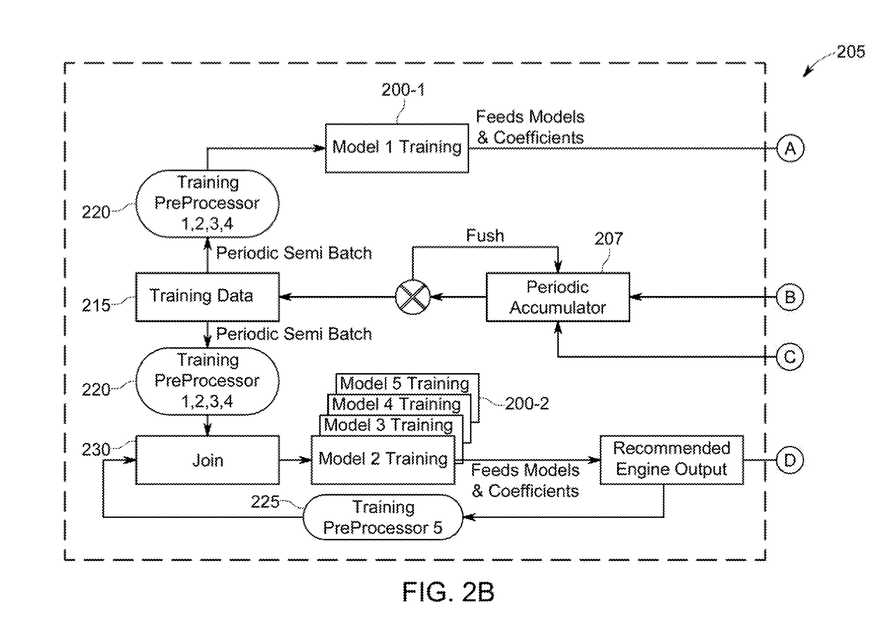

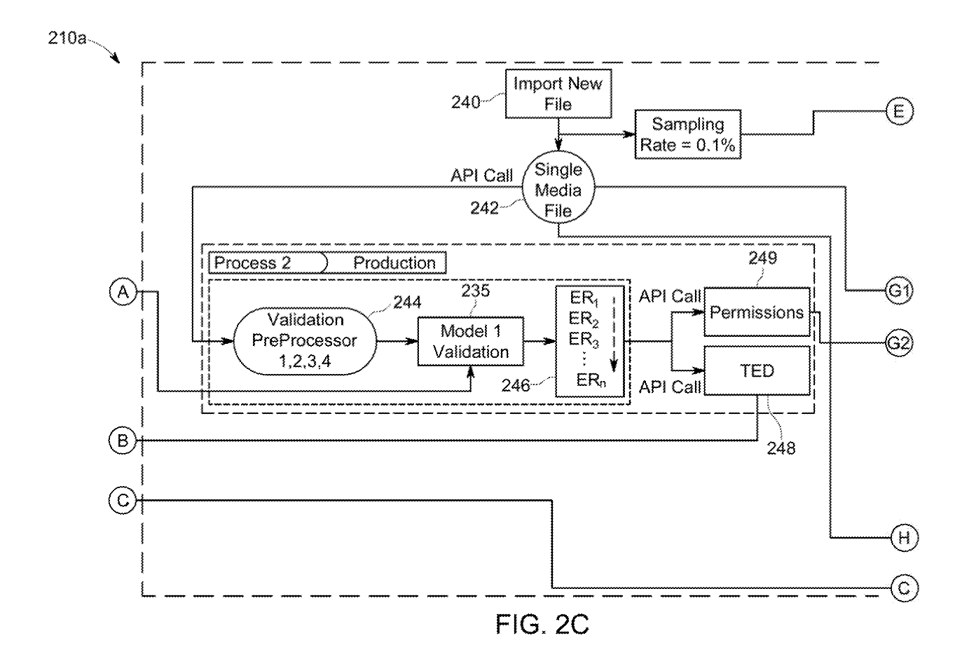

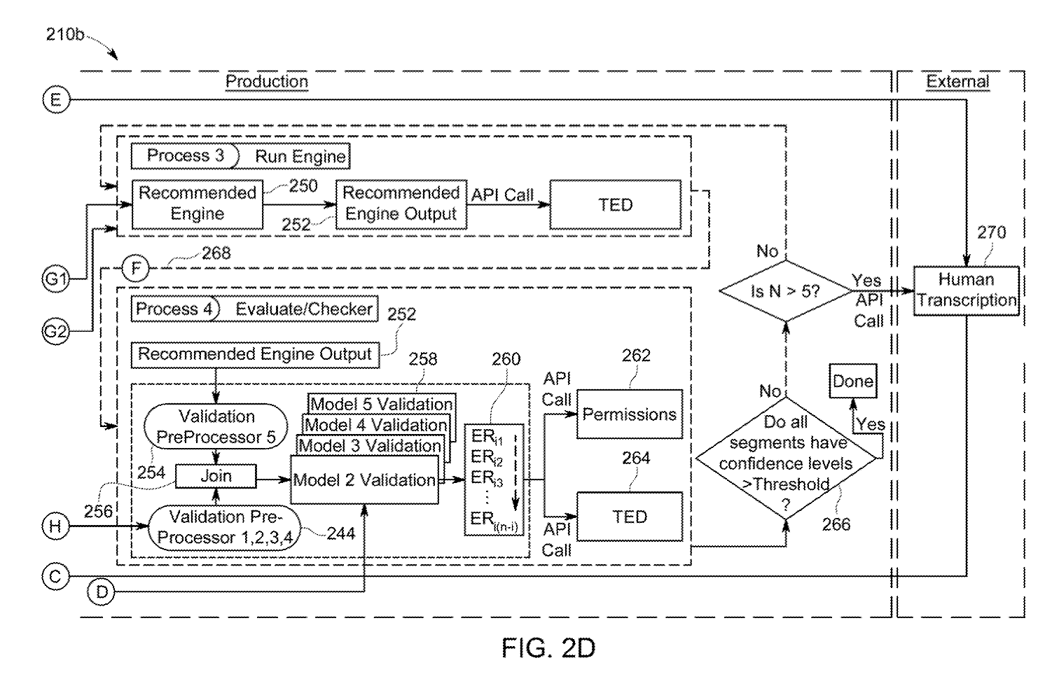

In some embodiments, seven preprocessors may be used to condition the data of the media file. They may include: an alphanumeric preprocessor, an audio analysis preprocessor, a continuous variable preprocessor, a categorical preprocessor, and a topical preprocessor (for topic identification and detection). The outputs of each preprocessor may be merged to form a single merged feature profile of the input media file. In some embodiments, during a first transcription cycle, only four preprocessors are used to condition the content of the input media file. The four preprocessors used in the first transcription cycle may include an alphanumeric preprocessor, an audio analysis preprocessor, a continuous variable preprocessor, and a categorical preprocessor. The selection, combination and execution order of these four preprocessors may be unique and provide advantages not previously seen. In some embodiments, some of the selected preprocessors may run substantially in parallel, or in any other sequences, for example, based on one or more dependencies between the preprocessors, or any predetermined order. These advantages may include more flexibility, better efficiency, better performances, better prediction accuracy, and other advantages that will become obvious as described below. In some embodiments, the alphanumeric preprocessor may convert certain alphanumeric values to real and integer values. The audio analysis preprocessor may generate mel-frequency cepstral coefficients (MFCC) using the input media file and functions of the MFCC including mean, min, max, median, first and second derivatives, standard deviation, variance, etc. The continuous variable preprocessor can winsorize and standardize one or more continuous variables. As known in the art, winsorizing or winsorization is the transformation of statistics by limiting extreme values in the statistical data to reduce the effect of possibly spurious outlier values. The categorical preprocessor can generate frequency paretos (e.g., histogram frequency distribution) of features in the feature profile generated by the alphanumeric preprocessor. The frequency paretos may include frequency distribution histograms categorized by word frequency, and may be used in topic identification, in this way the most important features may be identified, and/or prioritized. In some embodiments, these preprocessors may be referred to as validation preprocessors (see also FIGS. 2C-D).

At 110, a selected transcription model may be used to transcribe the input media file. The transcription model may be one that has been previously trained. The transcription model may include executing one or more preprocessors, and using outputs of the preprocessors (which can take the form of a joined feature profile of the new media file). The transcription model may also use numerous training data sets (e.g., thousands or millions). Using the joined feature profile and/or training data sets, the transcription model may then use one or more machine learning algorithms to generate a list of one or more transcription engines (candidate engines) with the highest predicted accuracy. The machine learning algorithms may include, but not limited to: a deep learning neural network algorithm; a gradient boosting algorithm (which may also be referred to as gradient boosted trees), and a random forest algorithm. In some embodiments, all three of the mentioned machine learning algorithms may be used to create a multi-model Foutput, through so-called “model stacking”.

As indicated, the transcription model may generate a list of one or more candidate transcription engines with the highest predicted accuracy that may be used to transcribe the content of the input media file received at 105. At 115, an initial transcription engine may be selected from the plurality of candidate engines to use in the initial round of transcription of the media file. The selection of the initial transcription engine may provide efficient input data for the subsequent procedures. In some embodiments, the transcription engine can be selected based on the highest predicted accuracy and the level of permission of the client. A permission level may be based on, for example, the price point or subscription level of the client. For example, a low price point subscription level can have access to a limited number of transcription engines while a high price point subscription level may have access to more or all available transcription engines.

At 120, the output of the selected transcription engine may be further analyzed by one or more natural language preprocessors now that the initial transcription of the media file is available. In some embodiments, a natural language preprocessor may be used to extract relationships between words, identify and analyze sentiment, recognize speech, and categorize topics. Each one of the extracted relationships, identified sentiments, recognized speech, and/or categorized topics may be added as a feature of a feature profile of the media file.

Similar to the preprocessing steps performed at 110, the content of the input media file may be preprocessed by a plurality of preprocessors such as, but not limited to, an alphanumeric, a categorical, a continuous variable, and an audio analysis preprocessor. In some embodiments, these preprocessors may run in parallel with the natural language processing (NLP), which is done by the NLP preprocessor. Alternatively, results generated by the plurality of preprocessors (not including the NLP preprocessor) at 110 may be reused. In some embodiments, the results and/or features from the plurality of preprocessors and the NLP preprocessor may be joined to form a joined feature profile, which is used as inputs for subsequent transcription models.

In this stage, the preprocessors may include an alphanumeric variable, a categorical variable, a continuous variable, an audio analysis, and a low confidence detection preprocessor. Results from each of the preprocessors—including results from the natural language preprocessor—may then be joined to create a single feature profile of the transcription output of the initial round.

At 125, at least another round of modeling may be performed. In this stage, the output of the selected transcription engine (transcription produced in the first round) may be evaluated by using the joined-feature profile (created at 120) as an input to one or more transcription models during the next (subsequent) round of modeling.

In some embodiments, the transcription model used at 125 may be the same transcription model at 110. Alternatively, a different transcription model may be used. Further, at 125, the transcription model may generate a list of one or more candidate transcription engines. Each candidate engine has a predicted accuracy for providing accurate transcription of the input media file. As more rounds of modeling are performed, the list of candidate transcription engines may be improved.

In some embodiments, the transcription engine with the highest predicted accuracy may be selected to transcribe one or more segments of the input media file. Depending on the size or type of the input media file, the input media file may be divided into one or more segments. The outputs (transcription of the input media file) from the selected transcription engine may then be analyzed to determine a confidence of accuracy or an accuracy value. The outputs may comprise a plurality of transcribed portions of the media file. Each transcribed portion corresponds to a segment of the input media file. At 130, if the confidence of accuracy of any transcribed portion is below a given accuracy threshold, then another transcription engine may be selected from the list of candidate transcription engines to re-transcribe the low confidence segment that corresponds to the transcribed portion having a low confidence of accuracy. A low confidence segment is a segment of the original input media file where its corresponding transcribed portion has a confidence of accuracy below a given accuracy threshold. In some embodiments, when a low confidence segment of input media file is identified, the entire input media file can be re-transcribed using another engine. In some embodiments, an entirely new transcription engine (not on the list of candidate transcription engine) can be selected to re-transcribe the low confidence segment.

After a new transcription engine is selected to re-transcribe the low confidence segment or the entire input media file, the input media file will have undergone at least two stages of transcription. Each subsequent transcription stage is generally more accurate than the previous transcription stage because the transcripts generated during previous stage(s) can be used as inputs to each subsequent transcription stage. In some embodiments, each subsequent transcription stage may include the use of a natural language preprocessor. As will be shown herein, processes 115, 120 and 125 may be repeated, thus the transcription process will ultimately be even more accurate each time it goes through another cycle.

Looking ahead to 135, a check may be done to determine whether the maximum allowable number of engines has been called or maximum transcription cycles have been performed. In some embodiments, the maximum allowable number of transcription engines that may be called is five, not including the initial transcription engine called in the initial transcription stage. Other maximum allowable number of transcription engines may also be considered. Once the maximum allowable number of transcription engines called is reached, a human transcription service may be used where necessary. Back at 130, if the confidence of accuracy or accuracy value of the entire input media file or each of the transcribed portions is above a certain threshold, then the transcription process is completed.

Process 100 may also include a training process portion 150. As indicated earlier, each time a media file is received for transcription, it may also be used for training existing transcription models in the system. At 155, one or more segments of the input media along with the corresponding transcriptions may be forwarded to an accumulator, which may be a database that stores recent input files and their corresponding transcriptions. The content of the accumulator may be joined with training data sets at 160 (described further below), which may then be used to further train one or more transcription models at 165. Thus, process 100 may continue to use real data for repeated training to improve its models.

One or more steps 110 through 165 can be considered to be part of the conductor which is configured to: train transcription models; select a transcription engine based on a trained model to transcribe the input media file; identify one or more segments of the transcribed media file with a low confidence of accuracy; select a new transcription engine to transcribe the one or more segments with a low confidence of accuracy; develop a new micro training model to transcribe one or more segments that cannot be transcribed to a desired level of accuracy by previously selected transcription engines (after several cycles); transcribe the one or more segments using a new micro engine, which is based on the new micro training model.

FIGS. 2A-E are exemplary flow diagrams showing further details of process 100 for optimizing the selection of transcription engines and for transcribing a media file in accordance with some embodiments of the present disclosure. FIG. 2A is a block diagram showing training process 205 and production process 210. FIGS. 2B-E show in further detail the processes and elements of FIG. 2A. Process 100 may include a training process 205 (shown in more detail in FIG. 2B) and a production process 210 (shown in more detail in FIGS. 2C-D).

FIG. 2B illustrates an exemplary detailed process flow of training process 205 which may be similar or identical to process 150 of FIG. 1 above. In some embodiments, process 205 may include a training module 200, an accumulator 207, a training database 215, preprocessor modules 220, and preprocessor module 225. In some embodiments, a module may include a hardware component. Preprocessor modules 220 may include an alphanumeric preprocessor, an audio analysis preprocessor, a continuous variable preprocessor, and a categorical preprocessor (shown as training preprocessors 1, 2, 3, 4). The database 215 may include media data sets which may include, for example, customers' ingested data, ground truth data, and training data. In some embodiments, the database 215 may be a temporal elastic database (TED).

Training module 200 may train one or more transcription models to optimize the selection of engines using a plurality of training data sets from training database 215. Training module 200, shown with training modules 200-1 and 200-2, may train a transcription model using multiple, e.g., thousands or millions, of training data sets. Each training data set may include data from one or more media files and their corresponding feature profiles and transcripts. Each training data set may be a segment of or an entire portion of a large media file. Additionally, each time a media file is ingested and transcribed, it can be added to the training data set.

A feature profile can be outputs of one or more preprocessors such as, but not limited to, an alphanumeric, an audio analysis, a categorical, a continuous variable, a low confidence detection, a natural language processing (NLP), and a topic modeling preprocessor. Each preprocessor may generate an output that includes a set of features in response to an input, which can be one or more segments of the media file or the entire media file. The output from each preprocessor may be joined to form a single cohesive feature profile of the media file (or one or more segments of the media file). A joining operation can be done at 220 or 230 (as shown in FIG. 2B) to merge outputs from each of the preprocessors.

Prior to training a transcription model using training modules 200, data of a training data set may be pre-processed in order to condition and normalize the input data. Each preprocessor may generate a feature profile of the input data (i.e., the input media file). A feature may include, among others, a deletion, an amendment, an addition, or a combination thereof to one of the metadata or data of the media file. For example, brackets in the metadata or the transcription data of the media file can be deleted. A feature can also include relationships between words, sentiment(s) (e.g., anger, happy, sad, boredom, love, excitement, etc.), recognize speech, accent, topics (e.g., sports, documentary, romance, sci-fi, politics, legal, etc.), noise profile(s), volume profile(s), and audio analysis variables such as mel-frequency cepstral coefficients (MFCC). The number of MFCCs generated may vary. In some embodiments, the number of MFCCs generated may be, for example, between 10 and 20.

In some embodiments, training module 200-1 may train a transcription model using training data sets from existing media files and their corresponding transcription data (where available). This training data is illustrated in FIG. 2B as coming from the database (TED) 215. As noted herein, the database 215 may be periodically updated with data from recently run models via an accumulator 207. In some embodiments, if a training data set does not have a corresponding transcript, then a human transcription may be obtained to serve as the ground truth (item 270 of FIG. 2D). Ground truth may refer to the accuracy of the training data set's classification. In some embodiments, training module 200-1 only trains a transcription model using only previously generated training data set, which is independent and different from the input media file. In contrast, in some embodiments, modeling module 200-2 may train one or more transcription models using both existing media files and the most recent data (transcribed data) available for the input media file. In some embodiments, the training modules 200-1 and 200-2 may include machine learning algorithms such as, but not limited to, deep learning neural networks; gradient boosting, random forests, support vector machine learning, decision trees, variational auto-encoders (VAE), and generative adversarial networks.

In some embodiments, input to the training module 200-3 may include outputs from a plurality of training preprocessors 220, which are combined (joined) with output from training preprocessor 225. Preprocessors 220 may include an alphanumeric preprocessor, an audio analysis preprocessor, a categorical preprocessor, and a continuous variable preprocessor. Preprocessor 225 may include one or more preprocessors such as, but not limited to, a natural language preprocessor to determine one or more topic categories; a probability determination preprocessor to determine the predicted accuracy for each segment; and a one-hot encoding preprocessor to determine likely topic of one or more segments. Each segment may be a word or a collection of words (i.e., a sentence or a paragraph, or a fragment of a sentence).

As noted above, accumulator 207 may collect data from recently run models and store it until a sufficient amount of data is collected. Once a sufficient amount of data is stored, it can be ingested into database 215 and used for training of future transcription models. In some embodiments, data from the accumulator 207 is combined with existing training data in database 215 at a determined periodic time, for example, once a week. This may be referred to as a flush procedure, where data from the accumulator 207 is flushed into database 215. Once flushed, all data in the accumulator 207 may be cleared to start anew.

FIG. 2C is an exemplary flow diagram illustrating in further detail portion 210a of the transcription engine selection optimization process 100. Portion 210a is part of the production process where preprocessors 244 and a trained transcription model 235 may be used to generate a list of candidate transcription engines 246 using real customers' media files as the input. At 240 and 242, a new media file is imported for transcription. The new media file may be a single file having audio data, image data, video data, or a combination thereof.

As shown, the input media file may be received and processed by one or more preprocessors 244, which may be similar to training preprocessors 220. Preprocessors 244 may include an alphanumeric preprocessor, an audio analysis preprocessor, a categorical preprocessor, and a continuous variable preprocessor (shown as preprocessors 1, 2, 3, 4). One of the major differences between training preprocessors 220 and preprocessors 244 is that the features and coefficients outputs of the training preprocessors 220 are obtained using thousands or millions of training data sets. Whereas, the features of preprocessors 244 are obtained using a single input (data set), which is the imported media file 240 along with certain values obtained during training such as medians of variables, used in missing value imputation, and values obtained during the winsorization calculations, and standardization calculations.

In some embodiments, preprocessors 244 may output a feature profile that may be used as the input for transcription model 235. The feature profile may include results from alphanumeric preprocessing, MFCCs, results from winsorization of continuous variables (to reduce failure modes), and frequency paretos of features in the feature profile of the input media file. In response to the feature profile input from preprocessors 244, transcription model module 235 may generate a list 246 of best candidate engines to perform the transcription of the input media file 240. In some embodiments, transcription model module 235 may use one or more machine learning algorithms to generate a list of candidate engines based on the feature profile of the input file and/or training data sets. The list of candidate engines can be top-ranked engines—engines that have high predicted accuracy. In some embodiments, if the top-ranked engine has the proper permission 249, then an API call may be made to request that transcription engine to transcribe the input media file 240. The output of transcription model module 235 may also be stored in a database 248, which can forward the collected data to accumulator 207, which accumulates data for future training. Similar to the database 215 described herein, the database 248 may include media data sets which may include, for example, customers' ingested data, ground truth data, and training data.

In some embodiments, parts of a preprocessor may be used for different input data (e.g., audio, image, text, etc.).

FIG. 2D is an exemplary flow diagram illustrating portion 210b of the transcription engine selection optimization process 100. Similar to portion 210a, portion 210b is part and continuation of the production process where one or more trained transcription models (as shown with label D) may be used to generate a list of candidate transcription engines using real customer data as the input (as shown with labels H and G1). Referring to process 3 in FIG. 2D, a recommended transcription engine 250 may be selected from the list of best candidate engines (shown with label G2, as recommended engine selected after permissions 249). In some embodiments, engine 250 may be selected based on the type of the media file, for example, a WAVE audio file, an MP3 audio file, an MP4 audio file, etc. Engine 250 may also be selected based on the topic of the input media file and/or metadata associated with the input media file. The engine 250 may be recommended because previous training associated the media file features with engine 250, e.g., based on performance of engine 250 for the type of the media file.

Engine 250 may generate an output 252, which may be a transcript and an array of confidences of accuracy. Output 252 may be stored in a database (TED) to train future transcription models.

An evaluation and check process (as shown in process 210b in FIG. 2D) may be run next. Output 252 may also be used as the input for preprocessor 254. In some embodiments, preprocessor 254 may be a natural language preprocessor that can analyze the outputted transcription to extract relationship between segments or words, analyze sentiment, and categorize topics, etc. Each one of the extracted relationships, identified sentiments, recognized speech, and/or categorized topics may be added as a feature of a feature profile of the media file.

Additionally, preprocessor 254 may also include a probability determination preprocessor to determine the predicted accuracy for each segment; and a one-hot encoding preprocessor to determine likely topic of one or more segments. Each segment can be a word or a collection of words (e.g., a sentence or a paragraph).

The evaluation and check process may also receive the media file 240 (see label H) and run it through one or more preprocessors 244. In some embodiments, the preprocessors 244 may include an alphanumeric preprocessor, an audio analysis preprocessor, a categorical preprocessor, and a continuous variable preprocessor (shown as preprocessors 1, 2, 3, 4).

Prior to performing another cycle of transcription using transcription engine model 258, which may be the same as transcription model 235 in FIG. 2C, the outputs of preprocessors 244 and 254 may be joined at 256. The main difference between transcription models 235 and 258 is that the latter can use actual transcription data, generated by the selected transcription engine at 250, of the input media file 240 to further improve the transcription accuracy.

At 260, transcription model 258, which may be a regression analysis model, generates a list 260 of best candidate engines (e.g., ranked by engine ranks, or ER's) that may be used to transcribe one or more segments of input media file 240 based on the multi-dimensional confidence array from output 252. At 262, the candidate engine with the highest rank and with the proper permission may be selected to transcribe one or more segments of the input media file 240. The output of the candidate engine may be a transcript of the media file and an array of confidence factors for one or more segments of the media file.

The list of the ranked engines at 260 may also be stored in database 264 (TED). Similar to the database 215 and 248 described herein, the database 264 may include media data sets which may include, for example, customers' ingested data, ground truth data, and training data. At 266, a check may be performed to determine whether all segments of the input media file have been transcribed with a certain level of confidence. If the confidence level (e.g., predicted accuracy) of all segments meets or exceeds a certain threshold, then the transcription process is completed. If the confidence level of any segment does not meet the threshold, the conductor can perform another transcription cycle on the segment (or on the entire media file) by looping back to 268 where another engine may be selected from the list of candidate engines (generated at 260) to re-transcribe the low confidence segment. The conductor can repeat the transcription loop many times until substantially all segments are transcribed at a desired level of confidence. In some embodiments, the maximum number of transcription loops may be set, for example, at five cycles as shown. If the confidence level is still low for one or more segments after the maximum transcription loops have been performed, then a human transcription may be requested at 270 or a new micro model and transcription engine can be generated to transcribe the problematic segment (i.e., a segment that cannot be transcribed to a desired level of accuracy after many cycles).

### Engine Selection Optimization & Topic Modeling

A conductor is a collection of processes (e.g., processes 100, 200, 300, 350, 400, 600, 700, and 900) that, at least, optimizes the selection of transcription engine(s) to transcribe a given input media file and identifies transcribed portions of the input media file that need to be reexamined and/or re-transcribed. One of the functions of the conductor is to perform predictive analytics (using trained machine learning model(s)) to select one or more transcription engines that could best transcribe a given input media file. Another function of the conductor is to identify transcribed portions of the input media file that need to be reexamined for potential re-transcription. The identification of transcribed portions that need to be reexamined can be done by determining the confidence of accuracy for each transcribed portion and/or performing textual analysis on each transcribed portion.

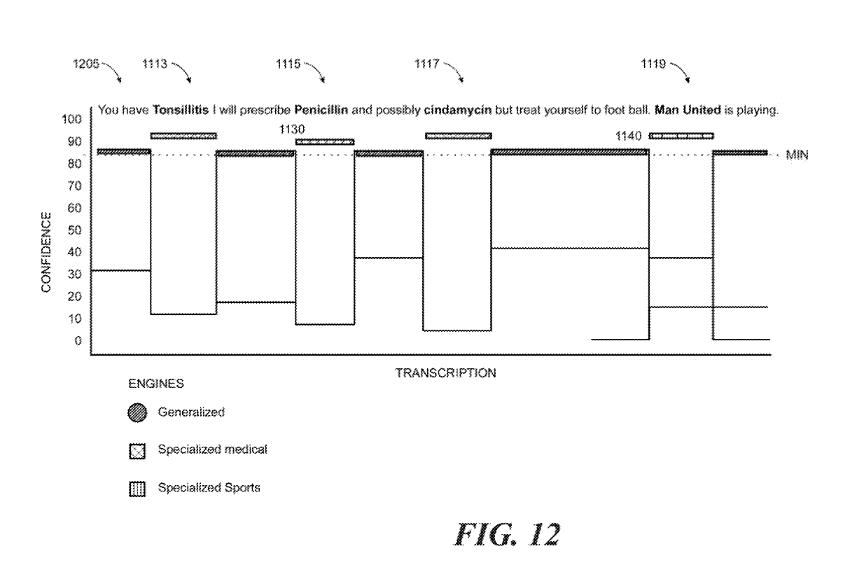

The confidence of accuracy for a transcribed portion can be determined based at least in part on transcription metadata of the transcribed portion, which can be provided by a transcription engine or can be locally generated based on at least words analytics on the transcribed portion and metadata of the input file. In some embodiments, transcription metadata can include a confidence value indicating the level of confidence the transcription engine assigned to each transcribed portion. The conductor can normalize the confidence value received from various transcription engines in order to compensate for the different confidence scales used by the various transcription engines. In some embodiments, the confidence of accuracy of a transcribed portion is based at least in part on the normalized confidence value. Next, the conductor can identify low confidence segments, using a transcription analyzer (e.g., 1409 of FIG. 12), based at least on the confidence of accuracy. Low confidence segments are segments of the input media file having corresponding transcribed portions with a level of confidence of accuracy below a minimum accuracy threshold. Once the transcription analyzer identifies low confidence segments, the conductor may select another transcription engine with the best expected improvement to transcribe the low confidence segments.

The identification of transcribed portions that need to be reexamined can also be done by performing textual analysis on each transcribed portion. Textual analysis can include one or more of, but not limited to, a contextual analysis, a grammatical analysis, a lexical analysis, a topical analysis, a word composition analysis (e.g., nouns, verbs, adjectives, preposition, etc.), and a sentiment analysis. If the results from a textual analyzer indicate that there is a high probability that transcribed portion is incorrect, then the transcribed portion can be flagged for reexamination and/or re-transcription. For example, if results from a contextual analyzer (of the textual analyzer) indicate that one or more words in the transcribed portion is out of context as compared to the entire transcribed portion and/or a portion or the entire input media file, then the transcribed portion can be flagged for reexamination and/or re-transcription. In another example, if results from a grammatical analyzer (of the textual analyzer) indicate that the transcribed portion is grammatically incorrect, then the transcribed portion can be flagged for reexamination and/or re-transcription. In yet another example, if results from a lexical analyzer (of the textual analyzer) indicate that one or more characters are out of place, then the transcribed portion may be flagged for reexamination and/or re-transcription.

In yet another example, if results from a topical analyzer (of the textual analyzer) indicate that the transcribed portion is likely to be incorrect in view of the topic of the transcribed portion or the input media file, then the transcribed portion may be flagged for reexamination and/or re-transcription. In this example, the topic of the input media file can be sports and the transcribed portion in question is “Roth less burger.” In this case, the topical analyzer can flag the transcribed portion because the likely correct spelling, considering the topic of the input media file is sports, is “Roethlisberger.” In yet another example, if results from a word composition analyzer (of the textual analyzer) indicate that the transcribed portion contains three consecutive verbs, then the transcribed portion may be flagged for reexamination and/or re-transcription.

In some embodiments, the textual analysis is performed by a textual analyzer, which can include a contextual analyzer, a grammatical analyzer, a lexical analyzer, a topical analyzer, a word composition analyzer, and a sentiment analyzer. The textual analyzer can include one or more machine learning algorithms configured to learn and perform contextual, grammatical, lexical, topical, composition, and/or sentiment analyses.

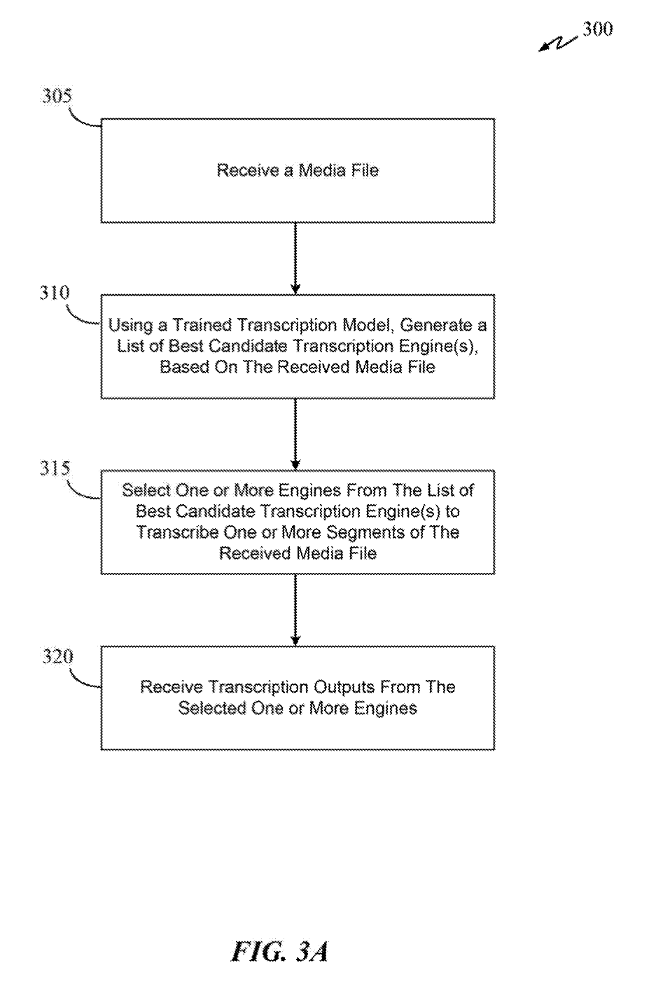

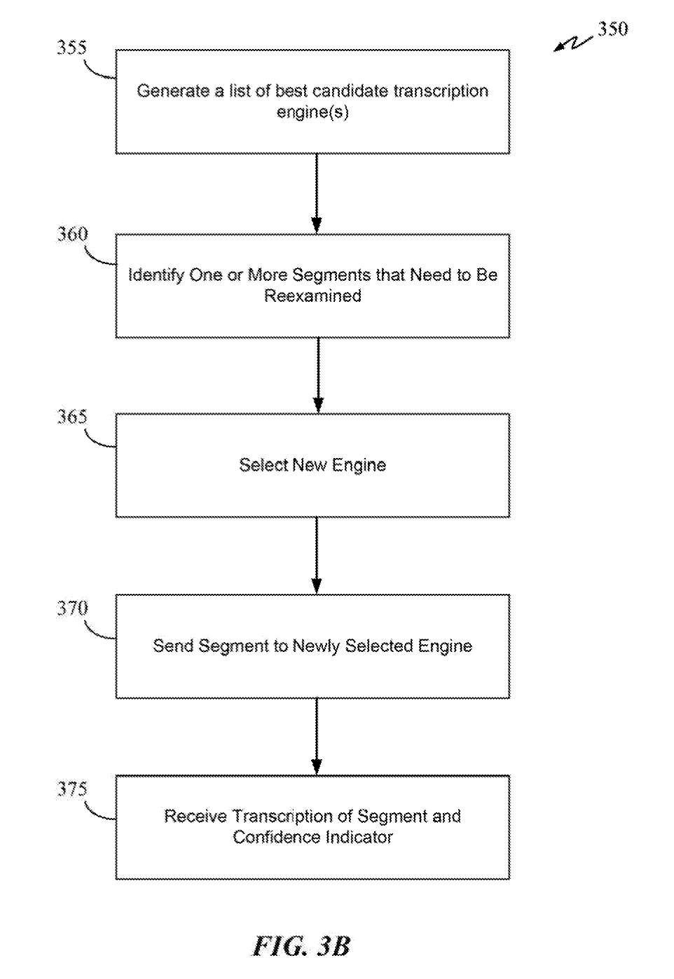

FIG. 3A illustrates a process 300 that can be implemented by the conductor (e.g., conductor 1250 of FIG. 12) to transcribe an input media file in accordance with some embodiments of the present disclosure. Process 300 starts at 305 Spwhen an input media file is received and ingested. In some embodiments, the input media file is preprocessed (e.g., preconditioned) to extract audio features of the input media file. In some embodiments, the audio features of the input media file can also be generated using a deep speech transcription model, which may include a trained recurrent neural network (RNN). The train RNN is configured to extract audio features based at least on phonemes of speech in the input media file.

At 310, using a trained transcription model (e.g., transcription model 235 or 258), to generate a list of best candidate transcription engines based on the features of the input media file. A best candidate transcription engine is a transcription engine having a predicted high level of accuracy for the input media file. A list of best candidate engines is a list of engines where each engine of the list has a predicted level of accuracy over a certain accuracy threshold such as above 80% accuracy. In some embodiments, the accuracy threshold has a range between 75% to 99%.

At 315, one or more engines from the list of best candidate engines are selected to transcribe one or more segments of the media file. In some embodiments, a single initial engine is selected to transcribe the entire media file. In another embodiment, two or more engines are selected to initially transcribe the media file. In this embodiment, each engine of the two or more selected engines is assigned to transcribe a different segment of the media file. The assignment of which engine to transcribe which segment of the media file can be based at least on the audio features of the corresponding segment.

At 320, the transcription outputs from the one or more engines are received. The outputs can be merged to form a merged transcription output.

FIG. 3B illustrates a process 350 that can be implemented by the conductor (e.g., conductor 1250 of FIG. 12) to improve the transcription of an input media file in accordance with some embodiments of the present disclosure. Process 350 is an engine selection optimization and transcription process, which starts at 355 where a list of best candidate transcription engine(s) is generated using one or more machine learning transcription models or algorithms. The one or more machine learning transcription models can be trained using a training data set that includes hundreds or hundreds of thousands of features profiles of media files and their corresponding transcriptions and/or transcription metadata. Once trained, the one or more machine learning transcription models can generate a list of best candidate transcription engines based at least on the features profile of the input media file, which is generated by one or more preprocessors (e.g., preprocessors module 220 and 225).

One of the transcription engines from the list of best candidate transcription engines is initially selected to transcribe the input media file. The transcription outputs from the initial or first transcription engine selected to transcribe the input media file are then analyzed. At 360, one or more segments of the input media file that need to be reexamined are identified. This can be accomplished by examining the transcription outputs in portions. A transcribed portion can include a single transcribed word or a group of words. Any transcribed portion of the transcription output can be flagged for reexamination when certain criteria are met.

In some embodiments, one of the criteria for reexamination is when the confidence of accuracy of each transcribed portion is below a minimum accuracy threshold. In some embodiments, outputs from the initial transcription engine can include a confidence indicator or value associated with each word in the transcription. The confidence score reflects the initial transcription engine's own metrics of how accurate each transcribed word is. There are many transcription engines, each can have its own metrics and method for calculating the confidence score. Accordingly, in some embodiments, process 350 can normalize confidence scores across various engines using, for example, linear regression. The normalization process can be performed in advance using one or more training data sets with ground truth transcriptions. Once normalized, the confidence score of each transcribed portion can be used to determine whether each transcribed portion is sufficiently accurate.

Each transcribed portion corresponds to a segment of the input media file, which could be determined by start and end time of the transcribed portion within the input media file. The start and end time or the positional data can be included in the transcription metadata. Using the transcription metadata, each transcribed portion can be associated with a particular segment of the input media file. At 360, segments of the input media that need to be reexamined can be identified by identifying transcribed portions having a low confidence of accuracy.

In some embodiments, segments of the input media that need to be reexamined can be identified by performing textual analysis on one or more transcribed portions of the output transcription. A textual analysis on a transcribed portion with respect to one or more other transcribed portions or the entire transcription can reveal potential error(s) in the transcription output. For example, an example transcription output can be “the dog chased the hat up the tree.” Although each word is spelled correctly, a textual analysis that analyzes the context of the transcription can reveal that the word “hat” is probably incorrectly transcribed and should be flagged to be reexamined. In some embodiments, textual analyses can be performed by a textual analyzer, which can include a contextual analyzer, a grammatical analyzer, a lexical analyzer, a topical analyzer, a word composition analyzer, and a sentiment analyzer. The textual analyzer can include one or more machine learning models configured to perform contextual, grammatical, lexical, topical, composition, and sentiment analyses. Each test or analysis within the textual analyzer can identify one or more segments that need to be reexamined by identifying the corresponding transcribed portions of the transcription that fail one or more of the analyses of the textual analyzer.

At 365, a new transcription engine can be selected by the conductor to transcribe one or more segments identified as segments that need to be reexamined, which can be low confidence segment(s) or segment(s) that fail one or more tests of the textual analyses. For a given input media file, there can be one or more low confidence segments. At 370, the one or more low confidence segments can be assigned to one or more new transcription engines. For example, low confidence segment A can be assigned to transcription engine #2 and low confidence segment B can be assigned to transcription engine #11. Alternatively, both segments A and B can be assigned to the same transcription engine. At 370, each of the low confidence segment (or segment that needs to be reexamined) is sent to its corresponding assigned/selected transcription engine. The new transcription engine selection can be done based on metadata, sentiments, topics, or a combination thereof. For example, transcription model module 235 can select a new transcription engine with the best expected improvement using the segment or the input media file's metadata, topic, and/or sentiment.

At 375, the transcription of each low confidence segment is received from the selected transcription engine (which is selected at 365). In some embodiments, a confidence score for each transcribed portion is also received, which will be normalized (using a transfer function) before it can be relied on. The confidence score can be analyzed again to determine whether the transcribed portion needs to be looped to step 355 again.

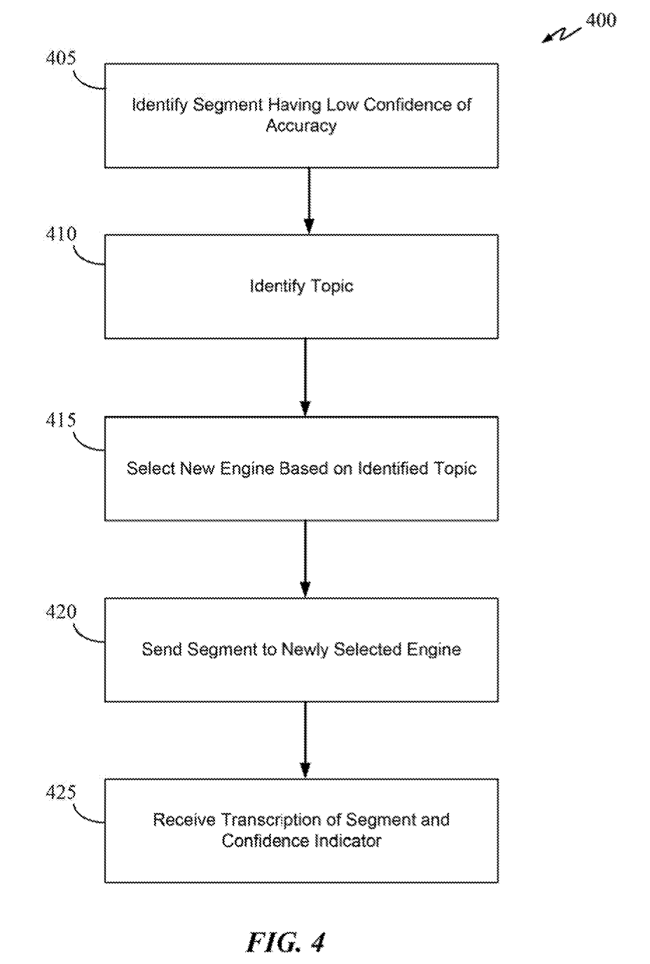

FIG. 4 illustrates an engine selection process 400 in which the conductor can implement to improve the transcription of an input media file in accordance with some embodiments of the present disclosure. Process 400 starts at 405 where the confidence score for each transcribed portion of the input media file is received and analyzed. If the confidence score of a segment is below a predetermined accuracy threshold (i.e., 90% probability of accuracy), the low confidence segment can be flagged for another round of transcription using a different transcription engine.

There are many commercially available third-party transcription engines such as Nuance, Dragon, and Bing Speech, etc. However, each engine can transcribe certain types of audio better than others. For example, Dragon may be better at transcription sports related audio than politics related audio, and Nuance may be better at transcription politics related audio than sports related audio. Accordingly, to increase the accuracy of a transcription, the conductor may first determine the topic of the low confidence segment (at 410) prior to selecting a new transcription engine. In some embodiments, one or more segments of the input media file may be analyzed to determine the topic. For example, only the low confidence segment is analyzed, or one or more adjacent segments can be analyzed along with the low confidence segment. Alternatively, the entire input media file containing the low confidence segment can be analyzed to determine the topic.

The topic of the low confidence segment (or the input media file) can be determined or modeled using various methods such as NLP, cluster analysis, and/or metadata analysis of the segment, multiple segments, or the entire input media file. Various NLP algorithms may be used to analyze the low confidence segment to determine the topic. For example, an NLP algorithm called rapid automatic keyword extraction (RAKE) may be used to extract keywords for topic identification. Others NLP algorithms such as latent Dirichlet allocation (LDA) and latent semantic indexing (LSI) may also be used to analyze the low confidence segment or the input media file to extract the topic. In certain cases, the low confidence segment or the input media file may have several topics. In these cases, a one-hot encoding may be performed to identify one of the main topics of the low confidence segment (or the input media file).

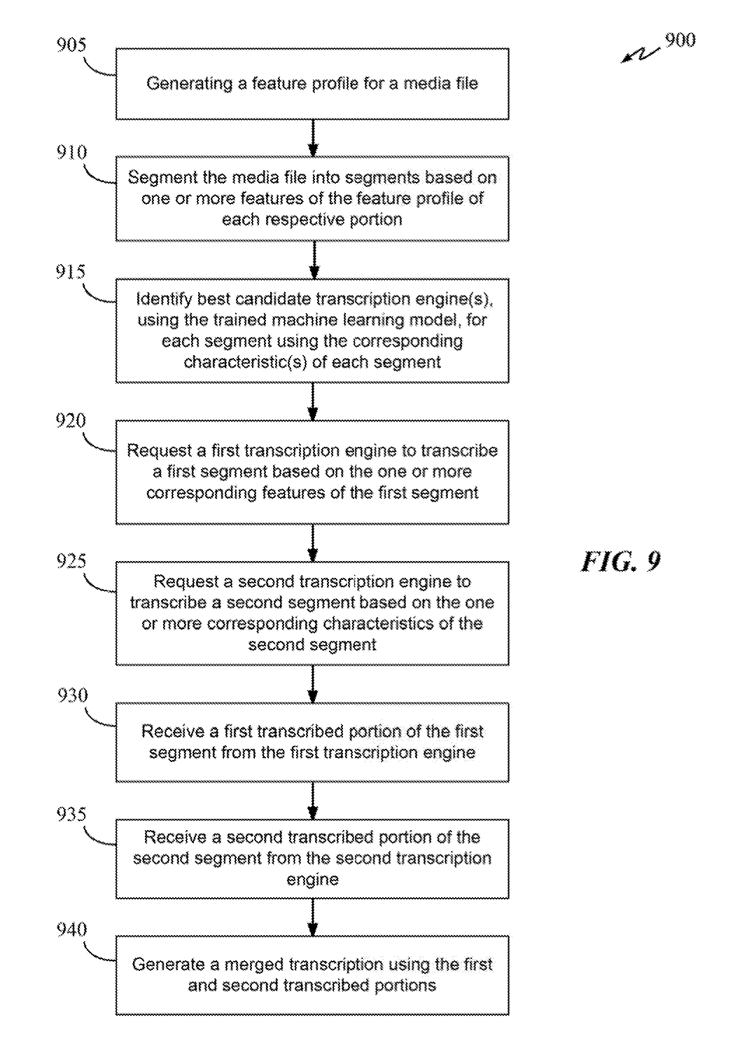

In some embodiments, a cluster analysis may be performed, by a textual analyzer (see item 1225 of FIG. 9) to determine the topic of the low confidence segment or the input media file. This may be done by treating the low confidence segment (or the entire input media file) as a collection of words, each of which will be clustered with words in other documents of known topics. In some embodiments, a cluster analysis may be performed on words in the low confidence segment against words in a collection of known topic documents such as sports, politics, law, medicine, business, pharmaceutical, history, archeology, etc. The topic module can determine the topic of the low confidence segment by analyzing whether the words in the segment are clustered more closely to one of the known topic documents. For example, if words in the low confidence segment are clustered very closely to the medicine document as compared to all other known topic documents, then the topic of the low confidence segment can be determined to be medicine.

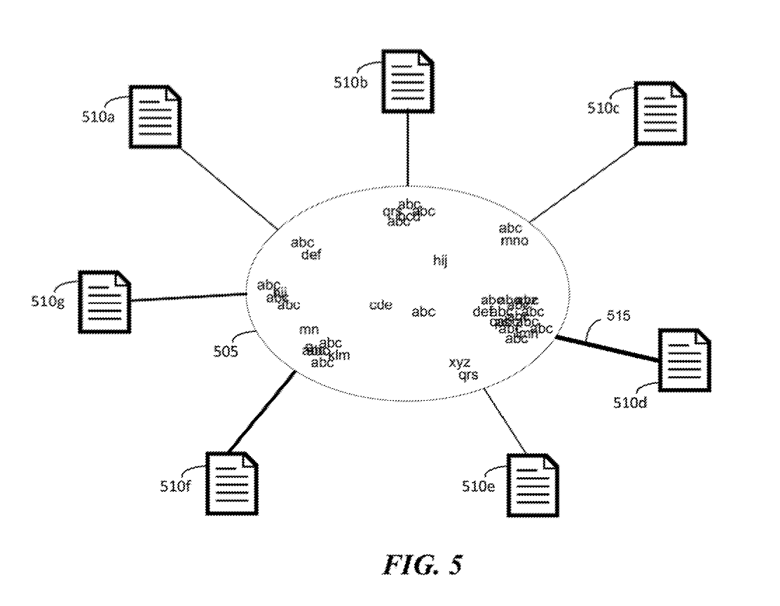

Referring to FIG. 5, which illustrates a clustering process 500 that generates text topic nodes in accordance with some embodiments of the present invention. Area 505 can represent clustered words of the input media file or the low confidence segments of the input media file. Process 500 can cluster texts or words in the one or more low confidence segments in groups near one of the known-topic documents 510a-g. As illustrated in FIG. 5, a strong relationship exists between the texts in the low confidence segment and document 510d, which is indicated by thick line 515. Also illustrated is thickness of line 515d (which is the thickest) as compared with all other lines connecting area 505 to each of the known-topic documents. In this embodiment, if the topic of document 510d is medicine, then the topic of the low confidence segment or the input media file can be determined to be medicine since line 515 is the thickest, which means the segment has the strongest association to document 510d.

In some embodiments, a topic may be extracted from the low confidence segment or input media file using a singular value decomposition (SVD) analysis. SVD is a type of a cluster analysis that maps clusters of words of the segment against clusters of words of documents of known topics. Essentially, an SVD analysis will identify which known-topic document is the closest to the low confidence segment. Process 500 can use a SVD clustering algorithm, a LSI algorithm, or other suitable text topic extraction algorithms.

The topic of the low confidence segment may also be determined by examining the metadata of the input media file. For example, if the metadata indicate that the source of the media file is from ESPN or the National Football League (NFL) and/or that the speaker is a well-known sport broadcaster, then the low confidence segment can be assumed to have sports as the topic. In another example, if the metadata indicate that the source of the media file is from a law firm taken at a deposition, then it may be determined that the topic is law.

Referring again to FIG. 4, at 415, once the topic of the low confidence segment is determined, a new engine can be selected to transcribe the low confidence segment. There are currently over 25 commercially available transcription engines—with a lot more available in the future. Each transcription engine has its own strengths and weaknesses, and each may transcribe certain topic better than others. The conductor can maintain a database of the strengths and weaknesses of each transcription engine. If for example, the transcription engine Bing Speech is very accurate in transcription medicine related media, then the conductor may select Bing Speech to transcribe the low confidence segment because it is identified to have medicine as the topic.

As previously described, transcription model module 235 may use one or more machine learning algorithms to generate a list of ranked engines based on the feature profile of the input media file and/or training data sets. In some embodiments, transcription model module 235 may modify the list of ranked engines based on identified topic of the low confidence segment. For example, transcription model module 235 may eliminate any transcription engine from the ranked list that is not suitable or strongly suited to transcribe the identified topic (e.g., medicine). In some embodiments, transcription model module 235 may eliminate all transcription engines not previously identified to be suitable to transcribe the identified topic at step 410. In some embodiments, transcription model module 235 may re-generate the list of ranked engine based on the combination of the feature profile and the identified topic. For example, transcription model module 235 may re-train the transcription model to generate a new list of ranked engines by using only training data sets having the same topic as the identified topic of the low confidence segment (or input media file).

At 420, the low confidence segment of the input media file is sent to the newly selected engine for transcription. In some embodiments, the entire input media file is sent to the newly selected transcription engine. At 425, a new or revised transcription of the low confidence segment is received along with the confidence indicator for each of the transcribed word.

### Micro-Model & Engine

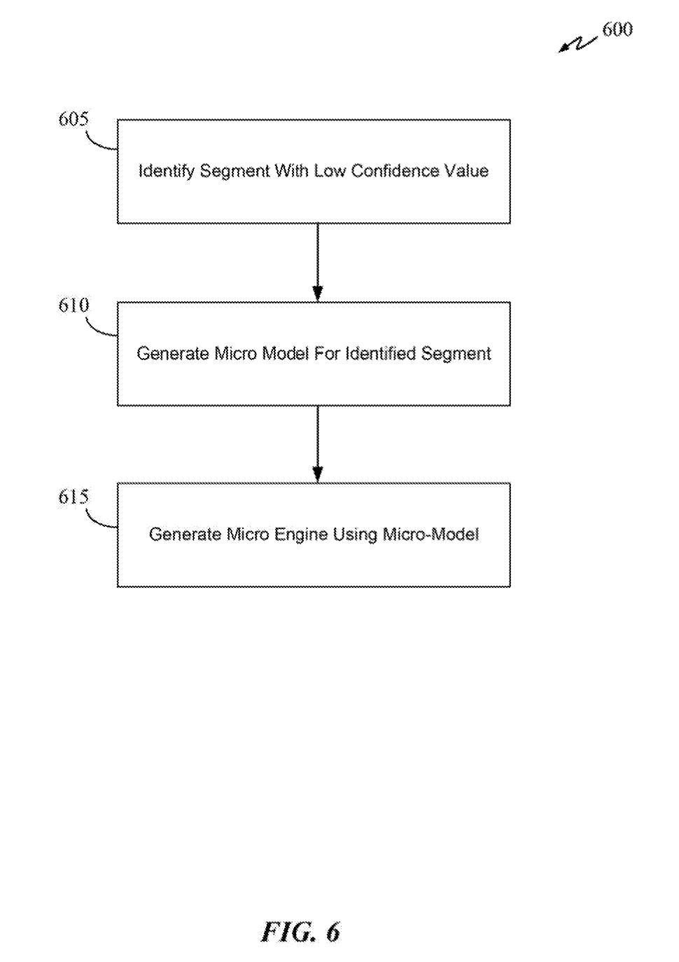

FIG. 6 illustrates a micro-model generation process 600 in which the conductor can implement to improve the transcription of an input media file in accordance with some embodiments of the present disclosure. Process 600 starts at 605 where segments of the input media file having transcribed portions with low confidence of accuracy are identified. As previously described, in some embodiments, low confidence segments can be assigned to a third party transcription engine for transcription—one that is different from a previously selected third party engine in a previous transcription cycle. However, if the transcription of the low confidence segment is still poor (low confidence value) after a predetermined number of transcription cycles (e.g., five), then a new micro-model and/or micro-engine can be generated at 610 to transcribe the persistently low confidence segment.

In some embodiments, the micro-model can be created using training data set having similar (or identical) metadata, feature profile, topic, sentiment, or a combination thereof. Metadata can include, but not limited to, source of the input media file or segment, identity of the speaker or speakers, type of file, encoding bit rate, etc. A micro-model can be generated by a modeling module (e.g., modeling module 200) using training data set having similar metadata such as using data set with the same speaker. In another example, a micro-model can be generated using training data set from the same source (e.g., EPSN) as the low confidence segment (or the input media file).

In some embodiments, a micro-model can be generated using training data set having the same topic as the low confidence segment. For example, if the low confidence segment is identified to have the topic of sports, then only training data set having sports as the topic will be used to train the micro-model.

In some embodiments, a micro-model can be generated using training data set having the same sentiment as the low confidence segment. For example, if the low confidence segment has a negative sentiment, then only training data set having negative sentiment will be used to train the micro-model. In some embodiments, a micro-model can be generated using training data set having one or more of the same topic, sentiment, audio features, and metadata. For example, if the topic of the low confidence segment is anthropology and the source is the National Geographic Channel, then only training data set from the National Geographic Channel with anthropology as the topic will be used to train the micro-model. At 615, a micro-engine is generated using the micro-model to transcribe the low confidence segment.

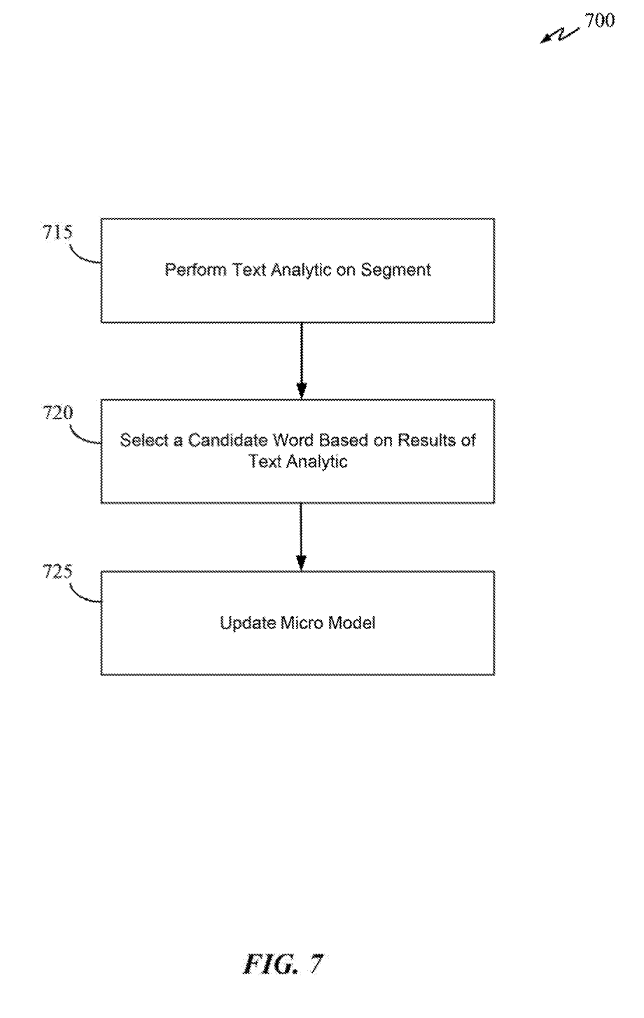

FIG. 7 illustrates a transcription process 700 that can be implemented by the micro-engine in accordance with some embodiments of the disclosure. In some embodiments, the micro-engine can be a specialized transcription engine created within or outside of process 100. The micro-engine can be an independent-standalone transcription engine that can be called by process 100 at stage 115, for example, to transcribe one or more persistently low confidence segments of the input media file.

In some embodiments, the micro-engine may perform a textual analysis on the texts or words of the low confidence segment. The textual analysis can be one or more of a grammatical analysis, a contextual analysis, a word composition analysis (e.g., nouns, verbs, adjectives, etc.), a topical analysis, and a sentiment analysis. Based on the textual analysis, the one or more persistently low confidence segments can be transcribed. In some embodiments, the one or more persistently low confidence segments can be transcribed by selecting words having high a probability of being the correct word from a table of candidate words.

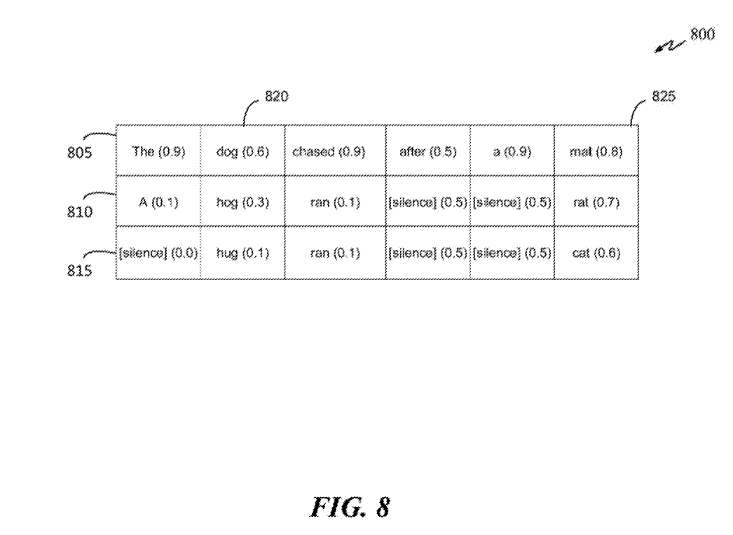

FIG. 8 illustrates an exemplary table 800 of candidate words and their corresponding probability of accuracy for each word in the low confidence segment in accordance with some embodiments of the disclosure.

Table 800 can have many rows; each row includes alternative transcription for each word in the low confidence segment. In some embodiments, the top most row (row 805) contains words having the highest probability of being correct. Similarly, the lowest row (row 815) contains alternative words having the lowest probability of being correct. In some embodiments, a transcribed sentence can have words from one or more rows. For example, the transcribed text can be “the hog chased after a cat,” which comprises of words from three different rows.

In table 800, each column can represent a time interval (e.g., start and stop time) within the low confidence segment. Each segment can have one or more words and thus one or more corresponding time intervals. In some embodiments, table 800 can be generated by a selected transcription engine at stage 115 and/or 120. Table 800 can be expanded or added to after each cycle of transcription by one or more transcription engines. Alternatively, table 800 can also be partially generated by the micro-engine. In some embodiments, table 800 can be entirely generated by the micro-engine.

Given table 800, the micro-engine can use textual analysis to determine whether the word in column 820 is a dog, hog, or hug. For example, based on word composition analysis of the segment, the micro-engine can eliminate the word “hug” in column 820 even if it has a high probability of accuracy because the output sentence would not have contained a subject. In another example, based on contextual analysis, the micro-engine can select “dog” for column 820 and “cat” for column 825. However, if the topic of the input media file was previously determined to be about rat, the micro-engine may select the word “rat” instead of “cat”.

In another example, a low confidence segment can contain the phrase “Ben Roe likes burger.” The confidence values for each word in “Roe likes burger” can be low (or very low) to trigger the generation of the micro-model and micro engine. In this example, to help with the transcription of the segment “Roe likes burger,” the micro-engine may analyze one or of the context, the topic, and metadata associated with the segment. Here, the micro-engine may determine that the topic of the input media file is football and the source is the National Football League. Since the topic is football, the micro-engine can retrain its training model using training data sets relating to football. Once the micro-model is retrained, the micro engine may re-transcribe the segment as “Ben Roethlisberger,” instead of “Ben Roe likes burger.”

In some embodiments, the micro-engine may also perform a contextual and/or metadata analyses to derive at the same transcription results.

Referring again to FIG. 7, at 725, the micro-model can be updated based on the newly transcribed portion at 720. The updated micro-model can then be used to generate a new micro-engine, which can get better at transcription after each update/revision cycle.

FIG. 9 illustrates a process 900 for transcribing a media file in accordance with some embodiments of the present disclosure. Process 900 starts at 905 where a feature profile for a media file is generated. A feature profile can be generated by one or more preprocessors (e.g., preprocessor modules 1205 of FIG. 12 and natural language processor). A feature profile can include data, but not limited to, such as relationships between words, sentiment(s) (e.g., anger, happy, sad, boredom, love, excitement, etc.), recognize speech, accent, topics (e.g., sports, documentary, romance, sci-fi, politics, legal, etc.), noise profile(s), volume profile(s), and audio analysis variables such as mel-frequency cepstral coefficients (MFCC).

At 910, the media file can be segmented into a plurality of segments based on one or more features of the feature profile. For example, a media file can have an audio segment in a sport stadium where the noise profile is strong, an audio segment where the speakers are whispering (e.g., low noise profile), and an audio segment with many people talking simultaneously. In this example, the media file can be segmented into three different segments: a first segment with a strong noise profile, a second segment with a low noise profile, and a third segment with multiple speakers. In another example, a media file can be segmented by topics. The media file can include data from a baseball game, a math lecture, and a legal proceeding. In this example, the media file can be segmented into a first segment relating to sports, a second segment relating to mathematics, and a third segment relating to law. In yet another example, a media file can be segmented into segments based on one or more predominant (e.g., main) features of a segment of the media file. A media file can be segmented into segments based on one or more predominant features such as, but not limited to, sentiments, volume profiles, and mel-frequency cepstral coefficients. In some embodiments, a media file can be segmented into a plurality of segments based on one or more features using one or more preprocessors (e.g., preprocessor modules 1205 of FIG. 12).

At 915, one or more best candidate engines are identified, using a trained machine learning transcription model, for each segment of the plurality of segments based at least in part on the predominant feature of the segment. For example, a first segment of the media file can have a strong noise profile and a second segment of the media file can include multiple speakers as the predominant feature. In this example, a modeling module is configured to identify, using a trained machine learning transcription model, one or more best candidate engines for each segment (e.g., the first and second segments). A best candidate engine is an engine having a predicted high probability of accuracy given one or more input features (e.g., high noise volume, multiple speakers, topic, and sentiment) of a segment of the media file or the entire media file. For example, for the first segment with a strong noise profile, engines F, D, and A can be identified as the best candidate engines in the order listed. For the second segment with multiple speakers, engines B, G, and T can be identified as the best candidate engines in the order listed. In another example, for a third segment relating to soccer, engines S, C, and R can be identified as the best candidate engines in the order listed. In this way, a media file can be transcribed in one or more segments using different best candidate engine(s) for each segment at the onset of the transcription process. In some embodiments, the one or more best candidate engines are identified using modeling module 1210 of FIG. 12.

At 920, a first transcription engine from the list of best candidate engines (e.g., engine F in the above example) is requested to transcribe the first segment. The first transcription engine is identified by the trained machine learning transcription model as the transcription engine with the highest predicted accuracy based on one or more features of the first segment. In some embodiments, the first transcription engine is identified by the trained machine learning transcription model based on a predominant feature of the first segment such as a volume profile, genre, a noise profile, a topic, a sentiment, etc.

At 925, a second transcription engine from the list of best candidate engines (e.g., engine B) is requested to transcribe the second segment. The second transcription engine is identified by the trained machine learning transcription model as the transcription engine with the highest predicted accuracy based on one or more features of the second segment. In some embodiments, the second transcription engine is identified by the trained machine learning transcription model based on a predominant feature of the second segment such as the genre (e.g., category) of the second segment. For example, the second segment can be segment of a soccer game.

In some embodiments, if the media file is segmented into ‘x’ number of segments, then a ‘x’ amount of transcription engines (identified by the trained machine learning transcription model) will be requested to transcribe each segment based on one or more features of the respective segment.

At 930, a first transcribed portion of the first segment is received from the first transcription engine in response to the request made at 920. In some embodiments, the first transcribed portion is received by a communication module (e.g., communication module 1230 of FIG. 12).

At 935, a second transcribed portion of the second segment is received from the second transcription engine in response to the request made at 925. In some embodiments, the second transcribed portion is received by a communication module (e.g., communication module 1230 of FIG. 12).

At 940, a merged transcription is generated using the received first and second transcribed portions. In some embodiments, the merging process can be done by conductor 1250 of FIG. 12.

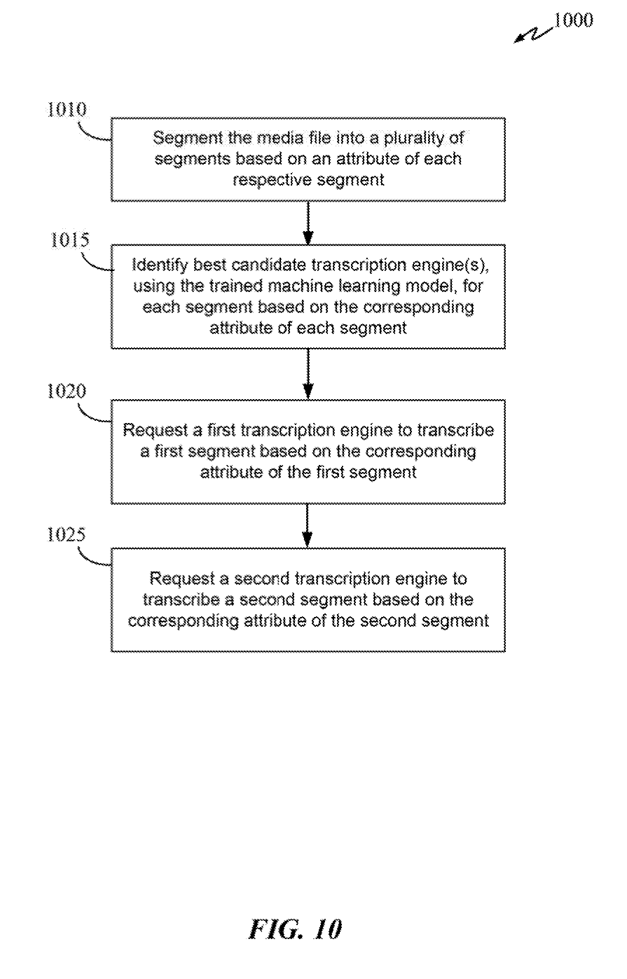

FIG. 10 illustrates a process 1000 for transcribing a media file in accordance with some embodiments of the present disclosure. Process 1000 starts at 1010 where a media file is segmented into a plurality of segments based on an attribute of each respective segment. An attribute of a segment can be a prominent audio feature (e.g., noise level, volume profile, intensity, relative power, pitch contour, etc.), a topic, a genre, a file type, encoding quality, etc. For example, a media file can have segments with varying noise levels (e.g., high, low) and pitch contour. For instance, the first 10 minutes of a media file is at a football game with very high background noise. The last 20 minutes of the same media file can be in a car with low background music. In this example, the media file can be segmented into two segments based on the background noise level and/or based on the context at the time of the recording (e.g., at the football game or a private location). In another example, the media file can be segmented base at least on the topic of each segment. A first segment of the media file can be related to sports (e.g., a video recording of a football game) and a second segment can be related to a legal proceeding (e.g., in a courtroom).

At 1015, using a trained machine learning model, the best candidate engine(s) for each segment of the media file is identified based on the corresponding attribute(s) for each segment. For example, a first segment of the media file can have a low-volume profile and a second segment of the media file can have a high-volume profile. In this example, the trained modeling module is configured to identify one or more best candidate engines for the first segment with the low-volume profile and the second segment with the high-volume profile.

At 1020, a transcription engine is selected from the one or more identified best candidate engines to transcribe the first segment of the media file. At 1025, another transcription engine is selected from the one or more identified best candidate engines to transcribe the second segment of the media file. Similar to process 900, a merged transcription can be generated using outputs from various transcription engines selected at 1015 and 1020.

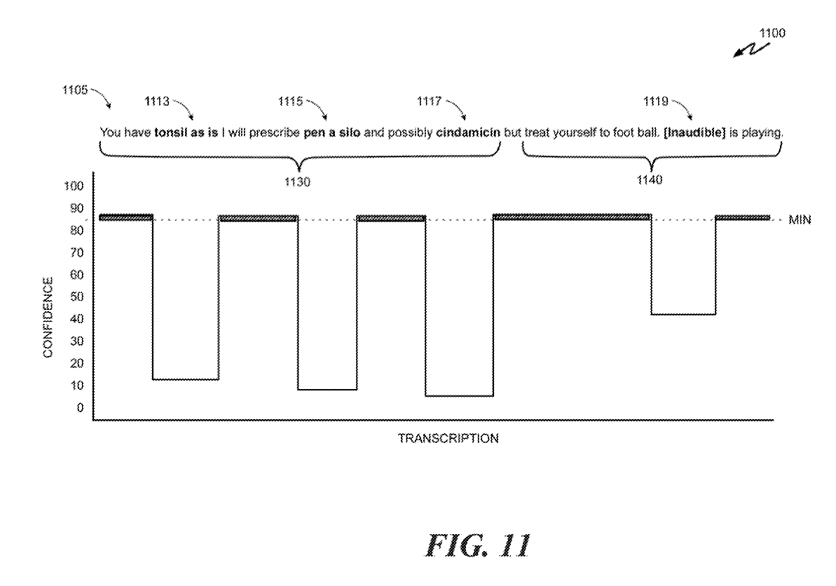

FIG. 11 illustrates a transcription confidence chart 1100 of an example transcribed portion 1105 in accordance with some embodiments of the present disclosure. Transcription confidence chart 1100 can be created using data collected and/or generated by, for example, process 100 at 130, process 200 at 266, process 350 at 355, process 400 at 405, and process 600 at 605 after the initial transcription round. In some embodiments, transcription confidence chart 1100 can be generated by process 100 at 130, process 200 at 266, process 350 at 355, process 400 at 405, and process 600 at 605 after the first round of transcription. For example, referring to FIG. 1, at 115, an initial or first transcription engine may be selected from the plurality of candidate engines to use in the initial round of transcription of the media file. Further, at 130, transcription metadata can be received from the first transcription engine or can be locally generated using metadata of the original input media file. Confidence values for transcription confidence chart 1100 can be determined based at least on the transcription metadata, which can include a confidence indicator for each word of transcribed portion 1105. Confidence data collected at 130, for example, can be used to generate confidence chart 1100 or simply to identify low confidence portions of transcribed portion 1105, which is the transcription output of the first transcription engine.

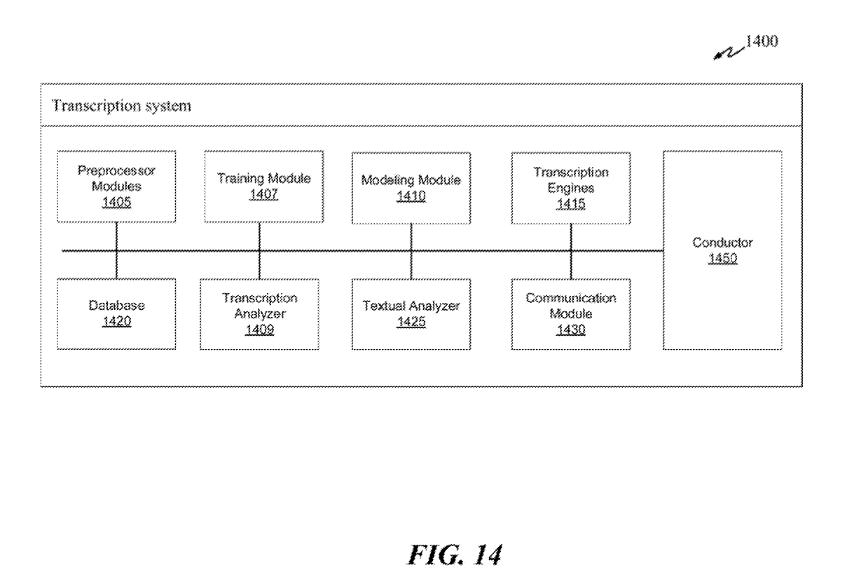

As shown in FIG. 11, transcribed portion 1105 includes words 1113, 1115, 1117, and 1119, each having a low confidence value. Each portion is associated with a segment of the input media file containing the audio of the word. In this example, portions 1113, 1115, 1117, and 1119 are found to have low confidence values or confidences of accuracy. These low confidence portions are then flagged for reexamination. In some embodiments, segments of the input file corresponding to low confidence portions 1113, 1115, and 1117 can be send to one or more specialized transcription engines for re-transcription. For example, low confidence portions 1113, 1115, and 1117 can be re-transcribed by a transcription engine that specializes in another area such as the field of medicine. In some embodiments, transcribed portion 1130 can be analyzed by a textual analyzer, which includes a contextual analyzer, a grammatical analyzer, a lexical analyzer, a topical analyzer, a word composition analyzer, and a sentiment analyzer. The textual analyzer (e.g., textual analyzer 1425 of FIG. 14) can include one or more machine learning models configured to perform contextual, grammatical, lexical, topical, composition, and sentiment analyses. In some embodiments, based on a contextual analysis of transcribed portion 1130, the textual analyzer can determine that portions 1113, 1115, and 1117 are likely related to the field of medicine.

Similarly, a textual analysis, using a textual analyzer, of transcribed portion 1140 can determine that transcribed portion 1119 is most likely related to sports. Thus, the segment of the input file that corresponds to low confidence portion 1119 can be re-transcribed by a transcription engine that specializes in sports. In other words, once the textual analyzer (e.g., textual analyzer 1425) determines that transcribed portion 1119 is most likely related to sports, conductor 1450 can selects another transcription engine that specializes in sports transcription to re-transcribe the audio segment that corresponds to transcribed portion 1119.

FIG. 12 illustrates a transcription confidence chart 1200 of transcribed portion 1105 after one or more re-transcription cycles in accordance with some embodiments of the present disclosure. As illustrated, once transcribed portions 1113, 1115, and 1117 are re-transcribed by a specialized medical transcription engine, each portion now has a high level of confidence of accuracy. Each portion also has the correct transcription after one or more subsequent re-transcription cycles. Similarly, transcribed portion 1119, which previously could not be transcribed by the first transcription engine (which can be a generalized transcription engine), is now correctly transcribed by a transcription engine that specializes in sports. In some embodiments, after each cycle of reexamination and re-transcription of low confidence segments, the conductor can examine each transcribed portion to determine whether a minimum threshold of accuracy is reached. For example, at 266 of process 200, the conductor checks to determine whether all segments of the input media file have been transcribed with a certain level of confidence. If the confidence level (e.g., predicted accuracy) of all segments meets or exceeds a certain threshold, then the transcription process may be completed. Once all segments are transcribed to a desired level of accuracy, the conductor can merge the transcription results from each transcription engine to generate a merged transcription of the input media file. In some embodiments, the conductor can analyze the transcription outputs (e.g., transcribed portion) for each segment of the input media file generated by one or more transcription engines and select the transcribed portion having the highest confidence of accuracy to generate a merged transcription. In other words, the merged transcription produced by the conductor can be a product of multiple transcription engines. For example, as shown in FIG. 12, the final version of transcribed portion 1205 is “You have Tonsillitis, I will prescribe Penicillin and possibly Clindamycin but treat yourself to football. Man United is playing.” All portions of transcribed portion 1205 are results from several transcription engines. In this example, transcribed portion 1205 is generated using transcription outputs from three different transcription engines. Each portion has a confidence of accuracy over a predetermined accuracy threshold, which can be set at 80 out of 100.

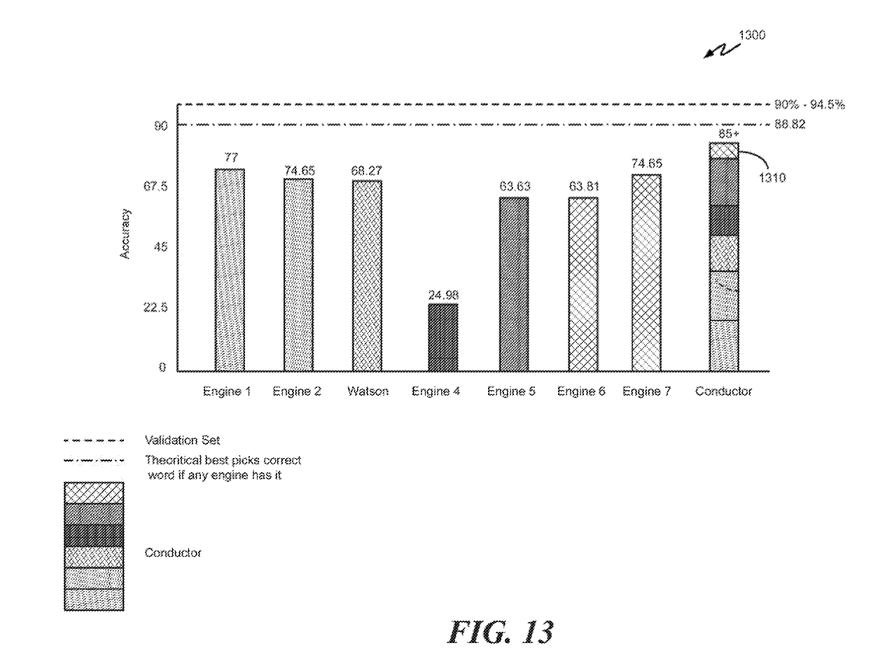

FIG. 13 is a chart illustrating the improvement of the transcription accuracy of the conductor (e.g., conductor 1450), as implement in accordance with embodiments of the present disclosure, over various transcription engines operating independently. As shown, the output transcription 1360 of a media file produced by conductor 1450 can be substantially more accurate than any transcription outputs of transcription engines 1 through 6 (that transcribed the same media file). Working alone, each of engines 1-6 cannot identify and rectify errors in its transcription output. As a result, the transcription outputs of engines 1-6 are all well below the minimum required/desired level of accuracy of 80. Engine 1 is the highest performer at 77, but this is still far off from the level of accuracy achieved by conductor 1450, which is over 85.

To achieve a high level of accuracy (85 or above), conductor 1450 uses a machine learning model to generate a list of transcription engines with the highest predicted accuracy. This takes out the guess work and eliminates the “try and see” approach, which manually selects a transcription engine(s) (essentially at random) to transcribe the input media file. For example, there are several hundreds of available third-party transcription engines from which to select. Without the conductor processes, the manual or the “try and see” approach in selecting a transcription engine is essentially random because there is no rule and/or guideline that guides the engine selection process from a very large field of over 200 engines. Additionally, the “try and see” approach is not only impractical, it is also resource intensive and costly. As illustrated in FIG. 13, no single engine can produce results with a high level of accuracy as conductor 1450, which leverages the strengths of various engines to produce a merged high-accuracy transcription.

Additionally, even assuming a company has unlimited resources and the capital to use the manual or the “try and see” approach, the manual selection of a transcription engine is still arbitrary because it is not based off a trained machine learning model and/or based off the audio features profile extracted from the input media file as implemented by conductor 1450. For example, as previously described, the input media file is preprocessed and analyzed by conductor 1450 to generate a merged audio features profile, which is then used by one or more machine learning algorithms to generate a list of transcription engines (candidate engines) with the highest predicted accuracy. The audio features profile of an input media file can include MFCC variables, rhythm, noise ratios, intensity, relative power, volume distribution, pitch contour, etc. These audio features simply cannot be extracted from the input media file and/or analyzed manually. In contrast, conductor 1450 includes training module 200 that trains one or more machine learning transcription models to select one or more transcription engines having the highest predicted accuracy based at least on the audio features profile of one or more input media files. Training module 200 may train a transcription model using multiple, e.g., thousands or millions, of training data sets. Each data set may include data from one or more media files and their corresponding feature profiles and transcripts. Accordingly, the conductor takes out the guess work of the engine selection process and thereby substantially improve the accuracy and speed of the overall transcription process.

### Example Embodiments

In a first example method for transcribing a media file using one or more processors, a list of transcription engines is generated using a trained machine learning model based at least on the media file. A first transcription engine, from the list of transcription engines, is requested to transcribe the media file. In response to requesting the first transcription engine to transcribe the media file, one or more transcribed portions of the media file are received. In the example method, a first transcribed portion from the one or more transcribed portions that needs to be reexamined is identified. A second transcription engine, from the list of transcription engines, is requested to transcribe a first segment of the media file corresponding to the first transcribed portion that needs to be reexamined. A second transcribed portion of the first segment is then received, from the second transcription engine, in response to requesting the second transcription engine to transcribe the first segment of the media file.

In a first aspect of the first example method, identifying the transcribed portion that needs to be reexamined comprises: receiving transcription metadata for the first transcribed portion from the first transcription engine; determining a confidence of accuracy for the first transcribed portions using the transcription metadata of the first transcribed portion; and identifying the first transcribed portion as a portion that needs to be reexamined based at least on the confidence of accuracy.

In an example of the first aspect of the example method, the confidence of accuracy for the first transcribed portion is determined by normalizing a confidence indicator that is included in the transcription metadata.

In a second aspect of the first example method, identifying the transcribed portion that needs to be reexamined comprises: performing a textual analysis on the first transcribed portion; and identifying the first transcribed portion as a portion that needs to be reexamined based on at least on results from the textual analysis. The second aspect of the first example method may be implemented in combination with the first aspect of the first example method, though the example embodiments are not limited in this respect.

In an example of the second aspect of the first example method, performing the textual analysis comprises performing at least one of: a contextual analysis; a grammatical analysis; a lexical analysis; a topical analysis; a word composition analysis; and/or a sentiment analysis.

In a third aspect of the first example method, generating the list of transcription engines further comprises: extracting audio features from the media file; and using the trained machine learning model, generating the list of transcription engines based at least on the extracted audio features of the media file. The third aspect of the first example method may be implemented in combination with the first and/or second aspect of the first example method, though the example embodiments are not limited in this respect

In a fourth aspect of the first example method, requesting the second transcription engine comprises selecting the second transcription engine based at least on a predicted topic of the first transcribed portion. The fourth aspect of the first example method may be implemented in combination with the first, second, and/or third aspect of the first example method, though the example embodiments are not limited in this respect.

In an example of the fourth aspect of the first example method, the predicted topic is determined by determining context the first transcribed portion.

In a second example of the fourth aspect of the first example method, the predicted topic is determined using metadata from the media file.

In a fifth aspect of the first example method, requesting the second transcription engine comprises creating a specialized transcription engine to transcribe the first segment. The specialized transcription engine is configured to transcribe the first segment based at least on an analysis selected from a group consisting of a contextual analysis, a grammatical analysis, a lexical analysis, a topical analysis, a cluster analysis, a word composition analysis, and a sentiment analysis. The fifth aspect of the first example method may be implemented in combination with the first, second, third, and/or fourth aspect of the first example method, though the example embodiments are not limited in this respect

In a sixth aspect of the first example method, the method further comprises: determining a confidence of accuracy for the second transcribed portions based at least on transcription metadata of the second transcribed portion; selecting a third transcription engine to transcribe the first segment when the confidence of accuracy is below the predetermined threshold; and generating a combined transcript of the media file using transcripts received from the first and third transcription engines, wherein the first, second, and third transcription engines are different. The sixth aspect of the first example method may be implemented in combination with the first, second, third, fourth, and/or fifth aspect of the first example method, though the example embodiments are not limited in this respect.

In a first example system for transcription a media file, the system comprises a memory and one or more processors. The one or more processors are coupled to the memory, the one or more processors are configured to: generate, using a machine learning model, a list of transcription engines based on the media file; request a first transcription engine to transcribe the media file; receive, from the first transcription engine, a plurality of transcribed portions of the media file in response to requesting the first transcription engine to transcribe the media file; identify a first transcribed portion from the one or more transcribed portions that needs to be reexamined; request a second transcription engine to transcribe a first segment of the media file corresponding to the first transcribed portion that needs to be reexamined; and receive, from the second transcription engine, a second transcribed portion of the first segment in response to requesting the second transcription engine to transcribe the first segment of the media file.

In a first aspect of the first example system, the one or more processors are further configured to: receive transcription metadata for the first transcribed portion from the first transcription engine; determine a confidence of accuracy for the first transcribed portions using the transcription metadata of the first transcribed portion; and identify the first transcribed portion as a portion that needs to be reexamined based at least on the confidence of accuracy.

In an example of the first aspect of the first example system, the confidence of accuracy for the first transcribed portion is determined by normalizing a confidence indicator that is included in the transcription metadata.

In a second aspect of the first example system, the one or more processors are further configured to: perform a textual analysis on the first transcribed portion; and identify the first transcribed portion as a portion that needs to be reexamined based on at least on results from the textual analysis. The second aspect of the first example system may be implemented in combination with the first aspect of the first example system, though the example embodiments are not limited in this respect.

In an example of the second aspect of the first example system, the textual analysis includes at least one of: a contextual analysis; a grammatical analysis; a lexical analysis; a topical analysis; a word composition analysis; and a sentiment analysis.

In a third aspect of the first example system, the one or more processors are configured to: extract audio features from the media file; and generate, using the machine learning model, the list of transcription engines based at least on the extracted audio features of the media file. The third aspect of the first example system may be implemented in combination with the first and/or second aspect of the first example system, though the example embodiments are not limited in this respect.

In a fourth aspect of the first example system, the second transcription engine is requested to transcribe the first segment based at least on a predicted topic of the first transcribed portion. The fourth aspect of the first example system may be implemented in combination with the first, second, and/or third aspect of the first example system, though the example embodiments are not limited in this respect.

In a fifth aspect of the first example system, the one or more processors are configured to: create a specialized transcription engine to transcribe the first segment. The specialized transcription engine is configured to transcribe the first segment based at least on an analysis selected from a group consisting of a contextual analysis, a grammatical analysis, a lexical analysis, a topical analysis, a cluster analysis, a word composition analysis, and a sentiment analysis. The fifth aspect of the first example system may be implemented in combination with the first, second, third, and/or fourth aspect of the first example system, though the example embodiments are not limited in this respect.

In a sixth aspect of the first example system, the one or more processors are further configured to: determine a confidence of accuracy for the second transcribed portions based at least on transcription metadata of the second transcribed portion; select a third transcription engine to transcribe the first segment when the confidence of accuracy is below the predetermined threshold; and generate a combined transcript of the media file using transcripts received from the first and third transcription engines, wherein the first, second, and third transcription engines are different. The sixth aspect of the first example system may be implemented in combination with the first, second, third, fourth, and/or fifth aspect of the first example system, though the example embodiments are not limited in this respect.

In a second example method for transcription a media file using one or more processors, the method comprises: selecting, using a machine learning model, a first transcription engine to transcribe the media file; receiving, from the first transcription engine, one or more transcribed portions of the media file in response to selecting the first transcription engine; identifying a first transcribed portion from the one or more transcribed portions having a confidence of accuracy below a predetermined accuracy threshold; selecting, using the machine learning model, a second transcription engine to transcribe a first segment of the media file corresponding to the first transcribed portion, the first and second transcription engines are different; receiving, from the second transcription engine, a second transcribed portion of the first segment; and selecting the first or second transcribed portion as transcript for the first segment of the media file based at least on confidences of accuracy of the first and second transcribed portions.

In a first aspect of the second example method, the method further comprises: receiving transcription metadata for the first and second transcribed portions from respective first and second transcription engines; and determining the confidence of accuracy for the first and second transcribed portions based at least on the transcription metadata for the first and second transcribed portions, respectively.

In an example of the first aspect of the second example method, the method further comprises: selecting, using the machine learning model, a third transcription engine to transcribe the first segment if the confidence indicator is below the predetermined threshold; and generating a combined transcript of the media file using transcripts received from the first and third transcription engines.

In a third example method for transcribing a media file using one or more processors, the method comprising: receiving, from a first transcription engine, one or more transcribed portions of a media file; identifying a first transcribed portion from the one or more transcribed portions that needs to be reexamined based at least on metadata of the media file; selecting a second transcription engine to transcribe a first segment of the media file corresponding to the first transcribed portion, the first and second transcription engines are different; receiving, from the second transcription engine, a second transcribed portion of the first segment; determining confidences of accuracy of the first and second transcribed portions of the first segment based at least on metadata of the first and second transcribed portions, respectively; and selecting the first or second transcribed portion as transcript for the first segment of the media file based at least on confidences of accuracy of the first and second transcribed portions.

In a fourth example method for transcribing a media file using one or more processors, the method comprising: receiving a media file; using a trained transcription model, generate a list of transcription engines having a predicted high level of accuracy; selecting a first engine from the generated list of transcription engines to transcribe the media file; and receiving a transcription output from the first engine in response to selecting the first engine to transcribe the media file.

### System Architecture

FIG. 14 is a system diagram of an exemplary transcription system 1400 for optimizing the selection of one or more transcription engines to transcribe a media file in accordance with some embodiments of the present disclosure. System 1400 may include one or more preprocessor modules 1405, training module 1407, transcription analyzer 1409, modeling module 1410, one or more transcription engines 1415, database 1420, textual analysis module (or textual analyzer) 1425, and communication module 1430, and conductor 1450. System 1400 may reside on a single server or may be distributed at various locations on a network. For example, one or more components (e.g., 1405, 1410, 1415, etc.) of system 1400 may be distributed across various locations throughout a network. Each component or module of system 1400 may communicate with each other and with external entities via communication module 1430. Each component or module of system 1400 may include its own sub-communication module to further facilitate with intra and/or inter-system communication.

Preprocessor modules 1405 include algorithms and instructions that, when executed by a processor, cause the processor to perform the respective functions and features of one or more preprocessors as described above with respect to processes 100, 200, 300, 350, 400, 600, 700, 900, and/or 1000. In some embodiments, preprocessor module 1405 is configured to identify and extract audio and/or video features of media data files.

Training module 1407 includes algorithms and instructions that, when executed by a processor, cause the processor to perform the respective functions and features of training module 200 as describe above and with respect to training related functions of processes 100, 200, 300, 350, 400, 600, 700, and/or 900.

Transcription analyzer 1409 includes algorithms and instructions that, when executed by a processor, cause the processor to perform the respective functions and features of a transcription analyzer as describe above and with respect to the determination of the confidence of accuracy of segment(s) of a media file as described in processes 100, 200, 400, 600, 700, and/or 900.

Modeling module 1410 includes algorithms and instructions that, when executed by a processor, cause the processor to perform the respective functions and features of the modeling module as describe above with respect to processes 100, 200, 300, 350, 400, 600, 700, and/or 900. In some embodiments, modeling module 1410 is configured generate a ranked list of transcription engines from which one or more engines may be selected to perform transcription of media data files. Modeling module 1410 can generate the ranked list of transcription engines based at least on audio features of the media file. Modeling module 1410 can implement machine learning algorithm(s) to perform the respective functions and features as describe above.

In some embodiments, output data from transcription engines 1415 may be accumulated in database 1420 for future training of transcription engines 1415. Database 1420 includes media data sets which may include, for example, customers' ingested data, ground truth data, and training data.

Transcription engines 1415 can include local transcription engine(s) and third-party transcription engines such as engines provided by IBM®, Microsoft®, and Nuance®, for example. Transcription engines 1415 can include specialized engines for medical, sports, movies, law, police, etc.

Textual analyzer or module 1425 includes algorithms and instructions that, when executed by a processor, cause the processor to perform the respective the functions and features of the textual analyzer as describe above with respect to processes 100, 200, 400, 600, 700, and/or 900. Textual analyzer 1425 can include a contextual analyzer, a grammatical analyzer, a lexical analyzer, a topical analyzer, a word composition analyzer, and a sentiment analyzer. Textual analyzer 1425 can include machine learning algorithm(s) configured to perform contextual, grammatical, lexical, topical, composition, and/or sentiment analyses on a transcribed portion of a transcript, an entire transcript, a segment of a media file, and/or the entire media file.

Conductor 1450 includes algorithms and instructions that, when executed by a processor, cause the processor to perform the respective the functions and features of the conductor as describe above with respect to processes 100, 200, 300, 350 400, 600, 700, and/or 900. For example, conductor 1450 includes algorithms and instructions that, when executed by a processor, cause the processor to: train transcription models based at least on the features profile of the input media file; select a transcription engine based on a trained model to transcribe the input media file; identify one or more segments of the transcribed media file with a low confidence of accuracy or segments that need to be reexamined based on results from textual analyzer 1425; select a new transcription engine to transcribe the one or more segments with a low confidence of accuracy or segments that have been identified as segments that need to be reexamined; and select a different transcription engine re-transcribe the identified segments with low confidence or flagged for reexamination. Conductor 1450 is also configured to develop a new micro training model to transcribe one or more segments that cannot be transcribed to a desired level of accuracy by previously selected transcription engines (after several cycles); and transcribe the one or more segments using a new micro engine, which is based on the new micro training model.

It should be noted that one or more functions of each modules 1405, 1407, 1409, 1410, 1415, 1425, and 1450 can be performed by one or more modules of transcription system 1400. For example, the confidence of accuracy for a segment or an entire media file can be determined using transcription analyzer 1409 and/or conductor 1450.

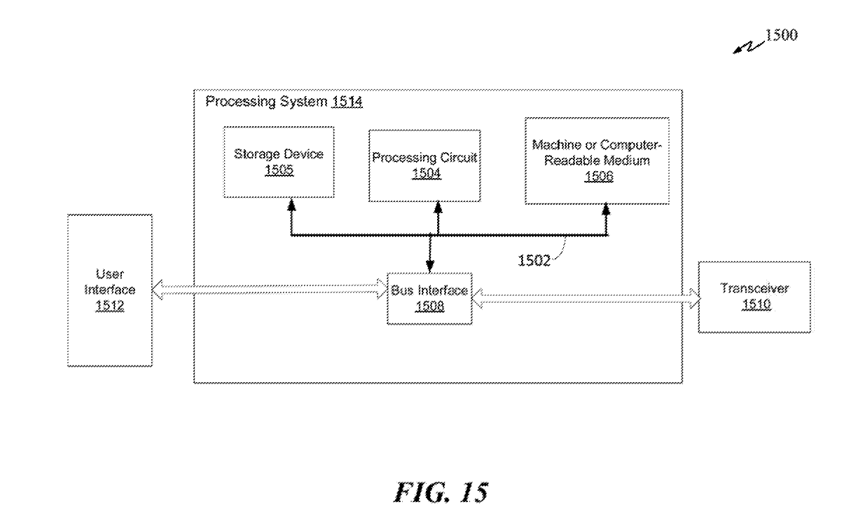

FIG. 15 illustrates an exemplary overall system or apparatus 1500 in which processes 100, 200, 300, 350, 400, 500, 600, 700, 900, and 1000 can be implemented. In accordance with various aspects of the disclosure, an element, or any portion of an element, or any combination of elements may be implemented with a processing system 1514 that includes one or more processing circuits 1504. Processing circuits 1504 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 1504 may be used to implement any one or more of the processes described above and illustrated in FIGS. 1, 2A-2D, 3, 4, 5, 6, 7, 8, 9, and 10.

In the example of FIG. 15, the processing system 1514 may be implemented with a bus architecture, represented generally by the bus 1502. The bus 1502 may include any number of interconnecting buses and bridges depending on the specific application of the processing system 1514 and the overall design constraints. The bus 1502 may link various circuits including one or more processing circuits (represented generally by the processing circuit 1504), the storage device 1505, and a machine-readable, processor-readable, processing circuit-readable or computer-readable media (represented generally by a non-transitory machine-readable medium 1509). The bus 1502 may also link various other circuits such as timing sources, peripherals, voltage regulators, and power management circuits, which are well known in the art, and therefore, will not be described any further. The bus interface 1508 may provide an interface between bus 1502 and a transceiver 1513. The transceiver 1510 may provide a means for communicating with various other apparatus over a transmission medium. Depending upon the nature of the apparatus, a user interface 1512 (e.g., keypad, display, speaker, microphone, touchscreen, motion sensor) may also be provided.

The processing circuit 1504 may be responsible for managing the bus 1502 and for general processing, including the execution of software stored on the machine-readable medium 1509. The software, when executed by processing circuit 1504, causes processing system 1514 to perform the various functions described herein for any particular apparatus. Machine-readable medium 1509 may also be used for storing data that is manipulated by processing circuit 1504 when executing software.

One or more processing circuits 1504 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

For example, instructions (e.g., codes) stored in the non-transitory computer readable memory, when executed, may cause the processors to: generate a feature profile for a media file; segment the media file into a first and second segment based at least on the feature profile, each segment has a corresponding portion of the feature profile;

identify one or more transcription engines having a predicted high level of accuracy, using a trained machine learning transcription model, for the first and second segments based at least on the corresponding portion of the feature profile of the first and second segments;
request a first transcription engine from the identified one or more transcription engines to transcribe the first segment; request a second transcription engine from the identified one or more transcription engines to transcribe the second segment; receive a first transcribed portion of the first segment from the first transcription engine in response to requesting the first transcription engine to transcribe the first segment; receive a second transcribed portion of the second segment from the second transcription engine in response to requesting the second transcription engine to transcribe the second segment; and generate a merged transcription using the first and second transcribed portions.

The software may reside on machine-readable medium 1509. The machine-readable medium 1509 may be a non-transitory machine-readable medium. A non-transitory processing circuit-readable, machine-readable or computer-readable medium includes, by way of example, a magnetic storage device (e.g., solid state drive, hard disk, floppy disk, magnetic strip), an optical disk (e.g., digital versatile disc (DVD), Blu-Ray disc), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 1509 may reside in the processing system 1514, external to the processing system 1514, or distributed across multiple entities including the processing system 1514. The machine-readable medium 1509 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

### CONCLUSION

The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

1. A method for transcription a media file using one or more processors, the method comprising:
generating, using a trained machine learning model, a list of transcription engines based at least on a feature of a media file;
requesting a first transcription engine, from the list of transcription engines, to transcribe the media file;
receiving, from the first transcription engine, one or more transcribed portions of the media file in response to requesting the first transcription engine to transcribe the media file;
identifying a first transcribed portion from the one or more transcribed portions that needs to be reexamined;
requesting a second transcription engine, from the list of transcription engines, to transcribe a first segment of the media file corresponding to the first transcribed portion that needs to be reexamined; and
receiving, from the second transcription engine, a second transcribed portion of the first segment in response to requesting the second transcription engine to transcribe the first segment of the media file.

2. The method of claim 1, wherein identifying the transcribed portion that needs to be reexamined comprises:
receiving transcription metadata for the first transcribed portion from the first transcription engine;
determining a confidence of accuracy for the first transcribed portions using the transcription metadata of the first transcribed portion; and
identifying the first transcribed portion as a portion that needs to be reexamined based at least on the confidence of accuracy.

3. The method of claim 2, wherein determining the confidence of accuracy for the first transcribed portion comprises normalizing a confidence indicator that is included in the transcription metadata.

4. The method of claim 1, wherein identifying the transcribed portion that needs to be reexamined comprises:
performing a textual analysis on the first transcribed portion; and
identifying the first transcribed portion as a portion that needs to be reexamined based on at least on results from the textual analysis.

5. The method of claim 3, wherein performing the textual analysis comprises performing at least one of:
a contextual analysis;
a grammatical analysis;
a lexical analysis;
a topical analysis;
a word composition analysis; or
a sentiment analysis.

6. The method of claim 1, wherein generating the list of transcription engines further comprises:
extracting audio features from the media file; and
using the trained machine learning model, generating the list of transcription engines based at least on the extracted audio features of the media file.

7. The method of claim 1, wherein requesting the second transcription engine comprises selecting the second transcription engine based at least on a predicted topic of the first transcribed portion.

8. The method of claim 7, wherein the predicted topic is determined by determining context the first transcribed portion.

9. (canceled)

10. The method of claim 1, wherein requesting the second transcription engine comprises creating a specialized transcription engine to transcribe the first segment, wherein the specialized transcription engine is configured to transcribe the first segment based at least on an analysis selected from a group consisting of a contextual analysis, a grammatical analysis, a lexical analysis, a topical analysis, a cluster analysis, a word composition analysis, and a sentiment analysis.

11. The method of claim 1, further comprising:
determining a confidence of accuracy for the second transcribed portions based at least on transcription metadata of the second transcribed portion;
selecting a third transcription engine to transcribe the first segment when the confidence of accuracy is below the predetermined threshold; and
generating a combined transcript of the media file using transcripts received from the first and third transcription engines, wherein the first, second, and third transcription engines are different.

12. A system for transcription a media file, the system comprising:
a memory;
one or more processors coupled to the memory, the one or more processor configured to: generate, using a machine learning model, a list of transcription engines based on the media file;
request a first transcription engine to transcribe the media file;
receive, from the first transcription engine, a plurality of transcribed portions of the media file in response to requesting the first transcription engine to transcribe the media file;
identify a first transcribed portion from the one or more transcribed portions that needs to be reexamined;
request a second transcription engine to transcribe a first segment of the media file corresponding to the first transcribed portion that needs to be reexamined; and
receive, from the second transcription engine, a second transcribed portion of the first segment in response to requesting the second transcription engine to transcribe the first segment of the media file.

13. The method of claim 12, wherein the one or more processors are further configured to:
receive transcription metadata for the first transcribed portion from the first transcription engine;
determine a confidence of accuracy for the first transcribed portions using the transcription metadata of the first transcribed portion; and
identify the first transcribed portion as a portion that needs to be reexamined based at least on the confidence of accuracy.

14. (canceled)

15. The method of claim 12, wherein the one or more processors are further configured to:
perform a textual analysis on the first transcribed portion; and
identify the first transcribed portion as a portion that needs to be reexamined based on at least on results from the textual analysis.

16. The method of claim 15, wherein the textual analysis includes at least one of: a contextual analysis;
a grammatical analysis;
a lexical analysis;
a topical analysis;
a word composition analysis; and
a sentiment analysis.

17. The method of claim 12, wherein the one or more processors are configured to: extract audio features from the media file; and
generate, using the machine learning model, the list of transcription engines based at least on the extracted audio features of the media file.

18. The method of claim 12, wherein the second transcription engine is requested to transcribe the first segment based at least on a predicted topic of the first transcribed portion.

19. The method of claim 12, wherein the one or more processors are configured to:
create a specialized transcription engine to transcribe the first segment, wherein the specialized transcription engine is configured to transcribe the first segment based at least on an analysis selected from a group consisting of a contextual analysis, a grammatical analysis, a lexical analysis, a topical analysis, a cluster analysis, a word composition analysis, and a sentiment analysis.

20. The method of claim 12, further comprising:
determine a confidence of accuracy for the second transcribed portions based at least on transcription metadata of the second transcribed portion;
select a third transcription engine to transcribe the first segment when the confidence of accuracy is below the predetermined threshold; and
generate a combined transcript of the media file using transcripts received from the first and third transcription engines, wherein the first, second, and third transcription engines are different.

21. A method for transcription a media file using one or more processors, the method comprising:
selecting, using a machine learning model, a first transcription engine to transcribe the media file;
receiving, from the first transcription engine, one or more transcribed portions of the media file in response to selecting the first transcription engine;
identifying a first transcribed portion from the one or more transcribed portions having a confidence of accuracy below a predetermined accuracy threshold;
selecting, using the machine learning model, a second transcription engine to transcribe a first segment of the media file corresponding to the first transcribed portion, the first and second transcription engines are different;
receiving, from the second transcription engine, a second transcribed portion of the first segment; and
selecting the first or second transcribed portion as transcript for the first segment of the media file based at least on confidences of accuracy of the first and second transcribed portions.

22. The method of claim 21, further comprising:
receiving transcription metadata for the first and second transcribed portions from respective first and second transcription engines; and
determining the confidence of accuracy for the first and second transcribed portions based at least on the transcription metadata for the first and second transcribed portions, respectively.

23. The method of claim 22, further comprising:
selecting, using the machine learning model, a third transcription engine to transcribe the first segment if the confidence indicator is below the predetermined threshold; and
generating a combined transcript of the media file using transcripts received from the first and third transcription engines.

24. (canceled)

25. (canceled)
